(19) United States
(12) Patent Application Publication
(10) Pub. No.: US 2014/0075075 A1
(43) Pub. Date: Mar. 13, 2014

(54) Context-Dependent Home Automation Controller and Docking Station

(71) Applicants: Daniel Lawrence Morrill, Mountain View, CA (US); Joe Freeman Britt, JR., Los Altos, CA (US)

(72) Inventors: Daniel Lawrence Morrill, Mountain View, CA (US); Joe Freeman Britt, JR., Los Altos, CA (US)

(73) Assignee: Google Inc.

(21) Appl. No.: 13/610,047

(22) Filed: Sep. 11, 2012

(51) Int. Cl. G06F 13/00

(52) U.S. Cl. 710/303

(57) ABSTRACT

A computer-implemented system includes a dock detector on a mobile computing device arranged to identify a type of docking station to which the device has been physically coupled, the identified docking station type selected from a plurality of docking station types, including a type associated with a light switch. The system also includes a repository of electronically stored user interface profiles that specify different schemes for presentations of information, where each profile corresponds to a type of docking station. The system further includes a user interface selector that is programmed to select, in response to the dock detector determining that the device has been mounted to a docking station of a type associated with a light switch, a first user interface profile from the repository that causes the device to be responsive to input to alter an illumination state of a lighting element associated with the light switch.

### TECHNICAL FIELD

This document generally relates to portable control units and docking stations for receiving the portable control units.

### BACKGROUND

Mobile computing devices such as smartphones may offer users rich experiences. Such devices may allow users to browse internet websites, download third-party application programs, use mapping applications that show a particular device's present geographical location on a map, and make telephone calls, among many possibilities.

Users can place a mobile device in a dock to power a battery of the device or to supplement the functionality of the device. For example, a dock may include a male data terminal that engages a female data terminal of the mobile device. The dock may create a snug fit with the mobile device to ensure that the data terminals are not damaged upon a user pivoting of the mobile device in any direction. Upon connection of the terminals, the dock can supply electrical power to the mobile device.

Upon the mobile device being placed into the dock, the display and associated functionality of the mobile device may change. For example, the display may change to indicate that the mobile device is charging. The display may remain substantially the same while the mobile device is connected to the dock, and may change back to an original display when the user removes the mobile device from the dock. Communication between the mobile device and the dock may be preconfigured and the device and dock may begin to communicate immediately upon user placement of the device in the dock, without user intervention.

### SUMMARY

This document describes techniques, methods, systems, and mechanisms for displaying a graphical interface. In general, a mobile computing device may be paired with a dock. Upon docking, the mobile device may determine a type of the dock, and may present a graphical user interface that is specific to the type of dock.

In a first general aspect, a computer-implemented system includes a dock detector on a mobile computing device arranged to identify a type of docking station to which the mobile computing device has been physically coupled, the identified type of docking station selected from a plurality of different possible docking station types, including a docking station type that is associated with a light switch. The system also includes a repository of electronically stored user interface profiles that specify different schemes for presentations of information with the mobile computing device, where each user interface profile corresponds to a type of docking station from the plurality of types of docking stations. The system further includes a user interface selector that is programmed to select, in response to the dock detector determining that the mobile computing device has been mounted to a docking station of a type that is associated with a light switch, a first user interface profile from the repository that causes the mobile computing device to be responsive to input to alter an illumination state of a lighting element associated with the light switch.

In various implementations, the system may further include a wall-mountable docking station adapted to be mounted in proximity to the light switch and to supply electrical power to the mobile computing device. The wall-mountable docking station may include a housing that is adapted to at least partially surround the light switch. The light switch may be accessible for actuation when the mobile computing device is not docked in the wall-mountable docking system, and an actuation of the light switch may result in an alteration of an illumination state of the lighting element. The light switch may be inaccessible for actuation when the mobile computing device is docked in the wall-mountable docking system, and an actuation of the light switch may not result in an alteration of an illumination state of the lighting element. The wall-mountable docking station may include a housing that is adapted to be mounted adjacent the light switch. The light switch may be accessible for actuation when the mobile computing device is not docked in the all-mountable docking system, and an actuation of the light switch may result in an alteration of an illumination state of the lighting element. An actuation of the light switch when the mobile computing device is docked in the wall-mountable docking system may not result in an alteration of an illumination state of the lighting element. The system may further include a second docking station adapted to supply electrical power to the mobile computing device, where the dock detector may be further programmed to determine that the mobile computing device has electrically coupled with the second docking station and may determine that the second docking station is a second type of docking station from the plurality of types of docking stations, and where the user interface selector may be further programmed to select a second user interface profile from the repository of user interface profiles based on the selected second user interface profile corresponding to the second type of docking station.

In a second general aspect, a computer-implemented method includes determining that a mobile computing device has electrically coupled by physical contact with a wall-mounted docking station mounted in proximity to a light switch, the wall-mounted docking station being adapted to supply electrical power for charging the mobile computing device. The method also includes determining that the wall-mounted docking station is a first type of docking station from a plurality of types of docking stations. The method further includes selecting a first user interface profile that corresponds to the first type of docking station from among a plurality of user interface profiles, each of the plurality of user interface profiles corresponding to a respective type of docking station from the plurality of types of docking stations. The method further includes presenting, by the mobile computing device for display, the first user interface profile in response to selecting the first user interface profile, the first user interface profile being responsive to an input at the mobile computing device to alter an illumination state of a lighting element associated with the light switch.

In various implementations, determining that the docking station is the first type of docking station may include receiving an electrical signal from the docking station that identifies the docking station as the first type of docking station in distinction to other of the plurality of types of docking stations. Each of the plurality of types of docking stations may receive the electrical signal over a same electrical interface configuration. The method may further include determining that the mobile computing device has not electrically coupled with the docking station before, and in response, may present, by the mobile computing device for display, a first configuration user interface as part of the first user interface profile.

In a third general aspect, a computer-readable storage device stores instructions that, when executed by one or more processing devices, perform operations that include determining that a mobile computing device has electrically coupled by physical contact with a wall-mounted docking station mounted in proximity to a light switch, where the wall-mounted docking station is adapted to supply electrical power for charging the mobile computing device. The operations may also include determining that the wall-mounted docking station is a first type of docking station from a plurality of types of docking stations, and selecting a first user interface profile that corresponds to the first type of docking station from among a plurality of user interface profiles, each of the plurality of user interface profiles corresponding to a respective type of docking station from the plurality of types of docking stations. The operations may further include presenting, by the mobile computing device for display, the first user interface profile in response to selecting the first user interface profile, the first user interface profile being responsive to an input at the mobile computing device to alter an illumination state of a lighting element associated with the light switch.

In a fourth general aspect, a computer-implemented system includes a dock detector that is programmed to (i) determine that a mobile computing device has coupled for charging with a wall-mounted docking station that is mounted in proximity to a wall-mounted light switch, and (ii) determine that the wall-mounted docking station is a first type of docking station from a plurality of types of docking stations. The system may also include a repository of electronically stored user interface profiles that specify different schemes for presentations of information with the mobile computing device, where each user interface profile corresponds to a type of docking station from the plurality of types of docking stations. The system further includes a user interface selector that is programmed to select a first user interface profile from the repository of user interface profiles based on the selected user interface profile corresponding to the first type of docking station, where the first user interface profile is selected for use by the mobile computing device in response to the dock detector determining that the mobile computing device has coupled with the wall-mounted docking station and that the wall-mounted docking station is a first type of docking station, where the first user interface profile is responsive to an input at the mobile computing device to after an illumination state of a lighting element associated with the wall-mounted light switch.

In various implementations, the system may further include a wall-mountable docking station adapted to be mounted in proximity to the wall-mounted light switch and to supply electrical power to the mobile computing device. The dock detector may be programmed to determine that the mobile computing device has electrically coupled for charging with the wall-mounted docking station. The dock detector may be programmed to determine that the mobile computing device has inductively coupled for charging with the wall-mounted docking station. The dock detector may be programmed to determine that the mobile computing device is not docked in the wall-mounted docking station but is within a proximity of the wall-mounted docking station, and, in response, a user interface of the mobile computing device may be updated to provide a control that can be used to alter an illumination state of the lighting element associated with the wall-mounted light switch.

The details of one or more embodiments are set forth in the accompanying drawings and the description below. Other features, objects, and advantages will be apparent from the description and drawings, and from the claims.

### DESCRIPTION OF DRAWINGS

FIG. 1 shows a typical location of a traditional wall-mounted light switch on a wall of a generic room.

FIGS. 2A, 2B, and 2C show examples of a wall-mountable docking station that can be adapted to supply power to a mobile computing device and cooperate with a wall-mounted light switch.

FIGS. 3A, 3B, and 3C show additional examples of a wall-mountable docking station that can be adapted to supply power to a mobile computing device and cooperate with a conventional light switch.

FIGS. 4A-4F show additional examples of all-mountable docking stations that can be adapted to supply power to a mobile computing device and cooperate with a conventional light switch.

FIG. 5 shows an example schematic diagram of a docked mobile computing device, and shows example user interfaces for mobile computing device when docked and when undocked.

FIG. 6 shows an example schematic diagram of a mobile computing device.

FIG. 7 shows an example desktop docking station for a mobile computing device.

FIG. 8A shows a partially transparent view of an example docking station in which a mobile computing device has been placed.

FIG. 8B shows a bottom view of an example mobile computing device.

FIG. 9 shows a flowchart of an example process for identifying a docking station that a mobile computing device has physically mated with, and for presenting an appropriate user interface.

FIG. 10 shows a flowchart of an example process for identifying a docking station that a mobile computing device has physically mated with, and for establishing a wireless connection with the docking station.

FIG. 11 shows a flowchart of an example process for displaying a dock-specific profile.

FIG. 12 shows a flowchart of an example process for maintaining a wireless connection upon undocking.

FIG. 13 shows an example system that includes a mobile computing device and a docking station.

FIG. 14 is a block diagram of computing devices that may be used to implement the systems and methods described in this document, as either a client or as a server or plurality of servers.

Like reference symbols in the various drawings indicate like elements.

### DETAILED DESCRIPTION

Traditional wall-mounted light switches are used to turn associated lights on or off, and have customary and well-known locations in rooms of houses, apartments, office buildings, and the like. Because of familiarity with these customary locations, people are generally able to locate light switches by memory or touch. Light switch locations tend to be so common, for example, that people can often locate a wall-mounted light switch without difficulty upon entering a dark room for the first time. Indeed, when entering a room, some people simply locate the light switch by touch without ever casting their gaze toward the switch.

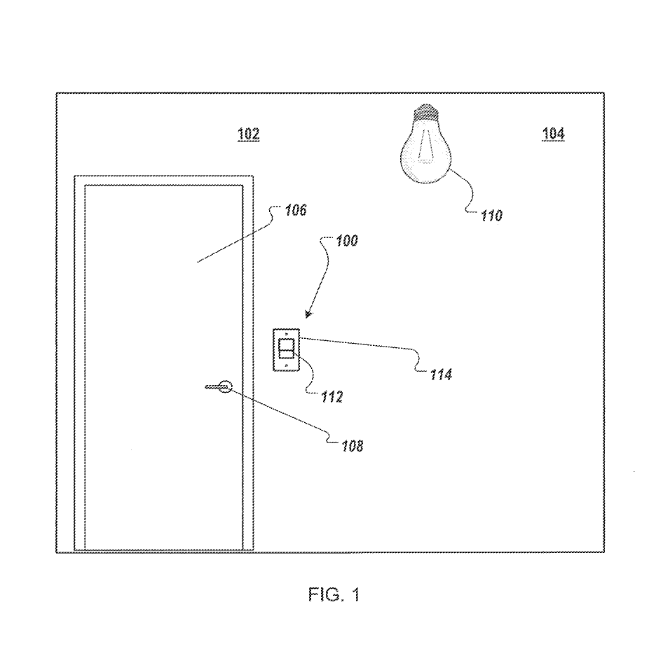

FIG. 1 illustrates a typical location of a traditional wall-mounted light switch 100 on a wall 102 of a generic room 104. The traditional light switch 100 is positioned generally near a door 106 that provides access to the room 104, usually on the same wall 102 that is shared by the door 106, and away from the hinges of the door 106. Frequently, the traditional light switch 100 is positioned within about ten to twenty-four inches of the door's handle 108 when the door 106 is dosed, for example. Such a location provides convenient access for someone entering or leaving the room, such that the room light or lights may be easily turned on or off, for example.

As is well known, actuation of a traditional light switch 100 causes a lighting element 110 to alter an illumination state. When the lighting element 110 is turned off, actuation of the traditional light switch 100 causes the lighting element 110 to turn on. Conversely, when the lighting element 110 is turned on, actuation of the traditional light switch 100 causes the lighting element 110 to turn off. Lighting element 110 is generically depicted as a single incandescent light bulb or lamp, but any of the various types of lighting elements for illumination may be used, including but not limited to fluorescent, halogen, metal halide, sulfur, high or low pressure sodium, and LED bulbs or lamps, among others. Also, actuation of the light switch 100 may cause one, two, three, or more bulbs or lamps to alter an illumination state, in various examples.

Traditional light switch 100 includes an actuation element 112 that, when actuated, causes the lighting element 110 to alter an illumination state. Examples of actuation element 112 can include a toggle switch, a push button, a rocker switch, or a pull chain, each of which may be two-position actuation elements. Multiple-position or continuous range actuation elements can also be used, such as elements that permit alteration between a fixed number of illumination states or over a continuous range of illumination states. Some actuation elements 112 may combine on/off operation control with dimming adjustment features, for example.

In general, the traditional light switch 100 can include a receptacle box (not shown) that is mounted in a recessed pocket of the wall 102 so that a forward edge of the receptacle box is generally flush with the surface of the wall 102. A face plate 114 can be mounted to the receptacle box to cover the contents of the receptacle box, and in some cases, to provide a decorative feature. The actuation element 112 typically protrudes through an aperture in the receptacle face plate 114.

Base stations or docks are commonly used to recharge mobile computing devices, and in some instances can be used to also communicate to or from a device. For example, a simple power cord can be used to recharge a device, while a music base system may provide power and may also receive data through the same physical connection that supplies the power (or may provide power through a physical connection while simultaneously transmitting data via a wireless data connection between the device and the dock), or a nearby physical connection, usually along an edge of the mobile computing device in a manner that allows a screen of the device to be visible to a user of the device while it is docked. The docking connections may be friction fittings so that a device may be inserted and removed easily, though cock locks may also be used to help ensure that a cord or other structure does not dislodge easily from the device.

A common problem with mobile computing devices such as remote control units is misplacing the mobile computing device. For example, remotes for controlling a television, sound system, lighting system, entertainment system, gaming system, web browsing system, and the like, can often be transported about a room or several rooms and indiscriminately placed so that the next time the device is needed, it may be difficult to find. This may be frustrating for a user, who may have to expend time and energy to locate the missing device.

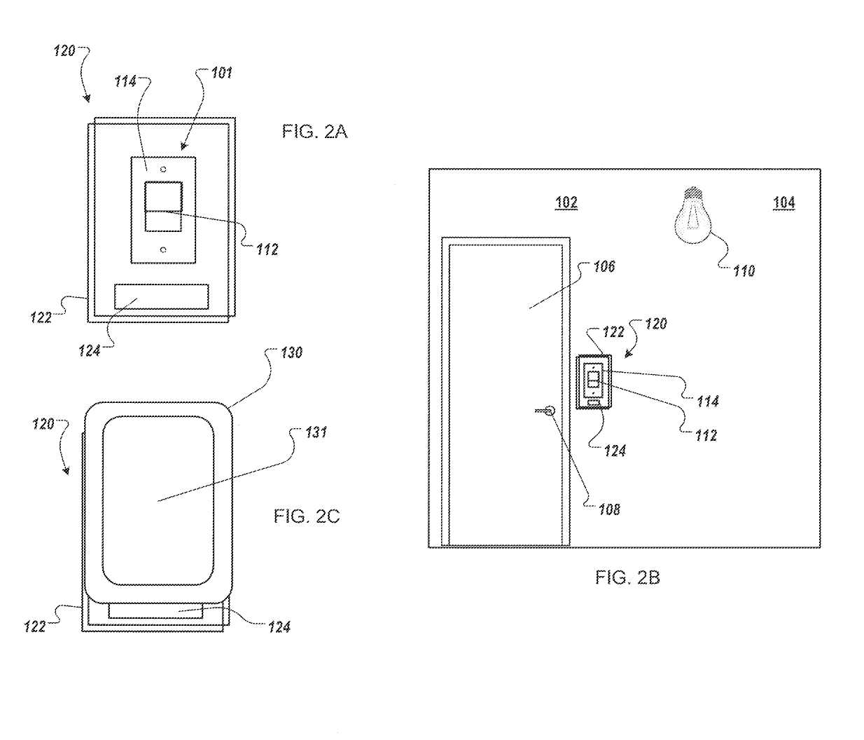

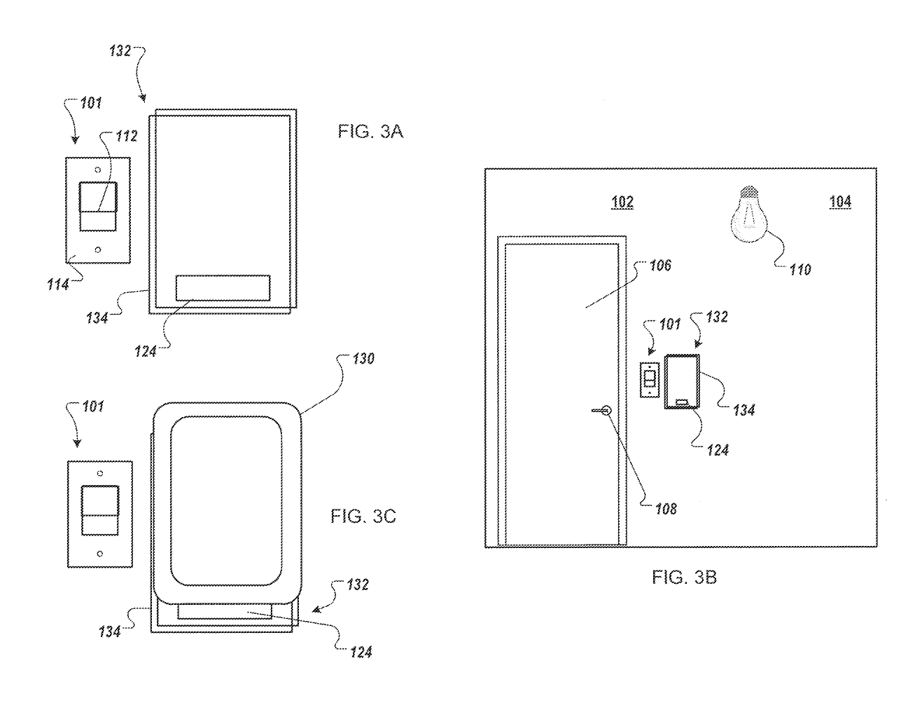

FIGS. 2A, 2B, and 2C, and 3A, 3B, and 3C show examples of wall-mountable docking stations that can be adapted to supply power to a mobile computing device and cooperate with a wall-mounted light switch. In various implementations, the wall-mountable docking stations may work in concert with the mobile computing device and a wall-mounted light switch to provide enhanced functionality. In some implementations, examples of mobile computing devices that may be docked in the example docking stations can include a home automation controller device, a remote control device (e.g., a universal remote control device programmable to control up to several devices or systems), a personal digital assistant (PDA) device, a smartphone, a tablet computing device, or similar types of rechargeable mobile computing devices.

In general, the docking station 120 may be adapted to be mounted in a proximity to the light switch 101. Because locations of traditional light switches are so familiar to users, as discussed above, locating a docking station 120 in proximity to a light switch may provide a user with a convenient and easy-to-remember location for storing the mobile computing device when not in active use. Such a location may also encourage a user to retrieve the mobile computing device from the docking station 120 upon entering the room (or just before exiting), which may provide the user with an improved user experience, for example, because additional features may be available to them with the undocked device, as will be discussed in more detail below.

In some implementations, the wall-mountable docking station 120 can be mounted on the wall 102 to surround or at least partially surround the light switch 101. FIGS. 2A, 2B and 2C show an example implementation where a housing 122 of the docking station 120 surrounds the light switch 101. The housing 122 of the docking station 120 in FIGS. 2A, 2B, and 2C surrounds the light switch 101 on all four sides of the light switch 101. In this example, the light switch 101 is positioned approximately in the center of the housing 122, but in other examples the light switch 101 could be positioned closer to an edge portion (e.g., the top portion, bottom portion, left portion, or right portion) of the housing 122. In the examples shown in FIGS. 2A-2C, the housing 122 is a generally rectangular-shaped housing and includes upper and lower portions and left and right portions.

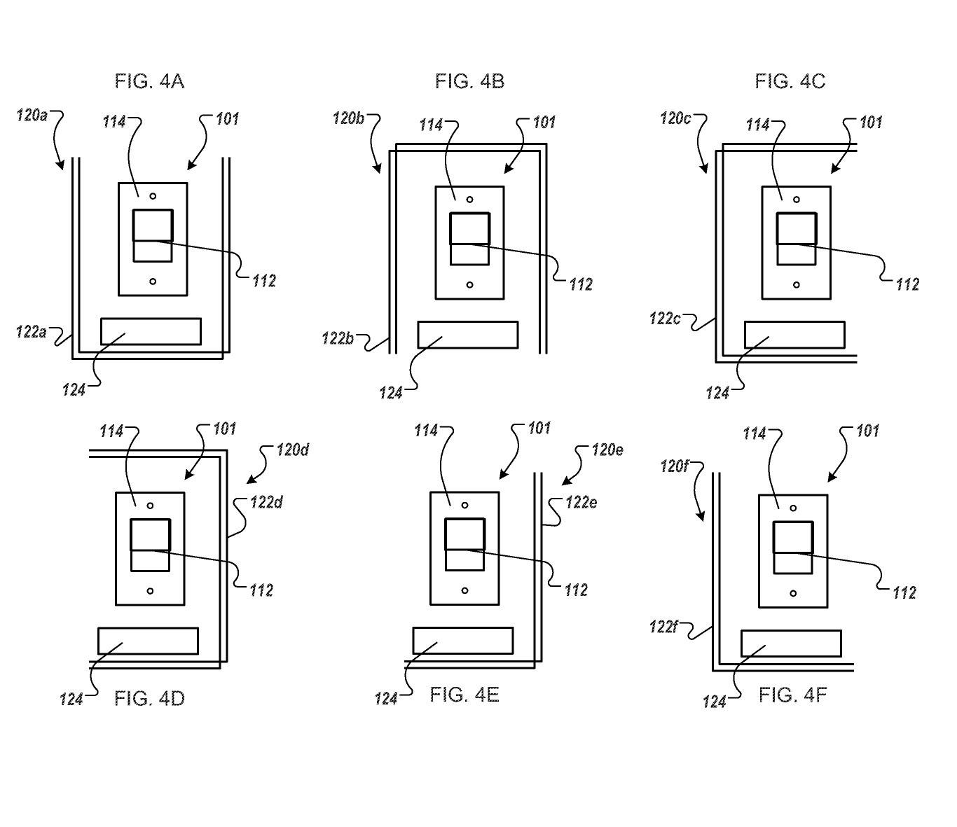

FIGS. 4A-4F show example docking stations 120a-f that include example housings 122a-f, respectively, that partially surround the light switch 101. The docking stations shown in FIGS. 4A-4D, for example, include housings 122a-d that partially surround the light switch 101 on three sides of the light switch, and may be generally U-shaped. For example, each of housings 122a-d may be nominally rectangular-shaped but may omit (as compared to housing 122 in FIG. 2A) one of the top portion (see FIG. 4A, housing 122a), bottom portion (see FIG. 4B, housing 122b), right portion (see FIG. 4C, housing 122c), or left portion (see FIG. 40, housing 122d).

The docking stations shown in FIGS. 4E and 4F, for example, include housings 122e, 122f that may partially surround the light switch 101 on two sides of the light switch. In some examples, the housing may be generally L-shaped, and may include a lower portion and a right portion (see FIG. 4E, housing 122e), or a lower portion and a left portion (see FIG. 4F, housing 122f). In other examples of housings that may partially surround the light switch 101 on two sides of the light switch 101, the housing may include, for example, upper and lower sides; or left and right sides. In some examples, a housing may include only one side, such as a lower side.

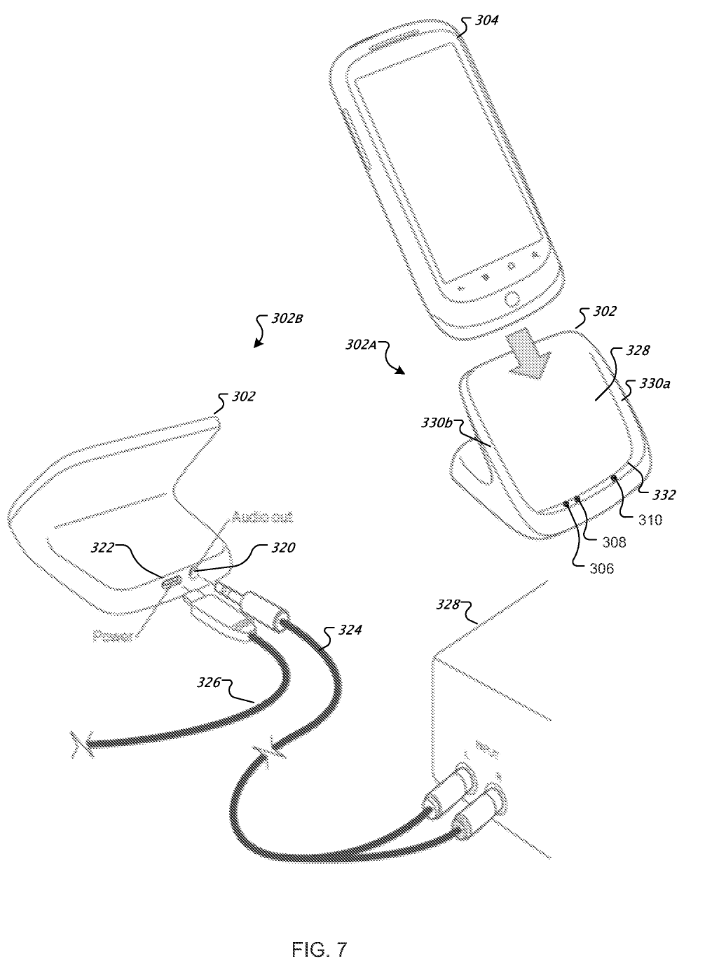

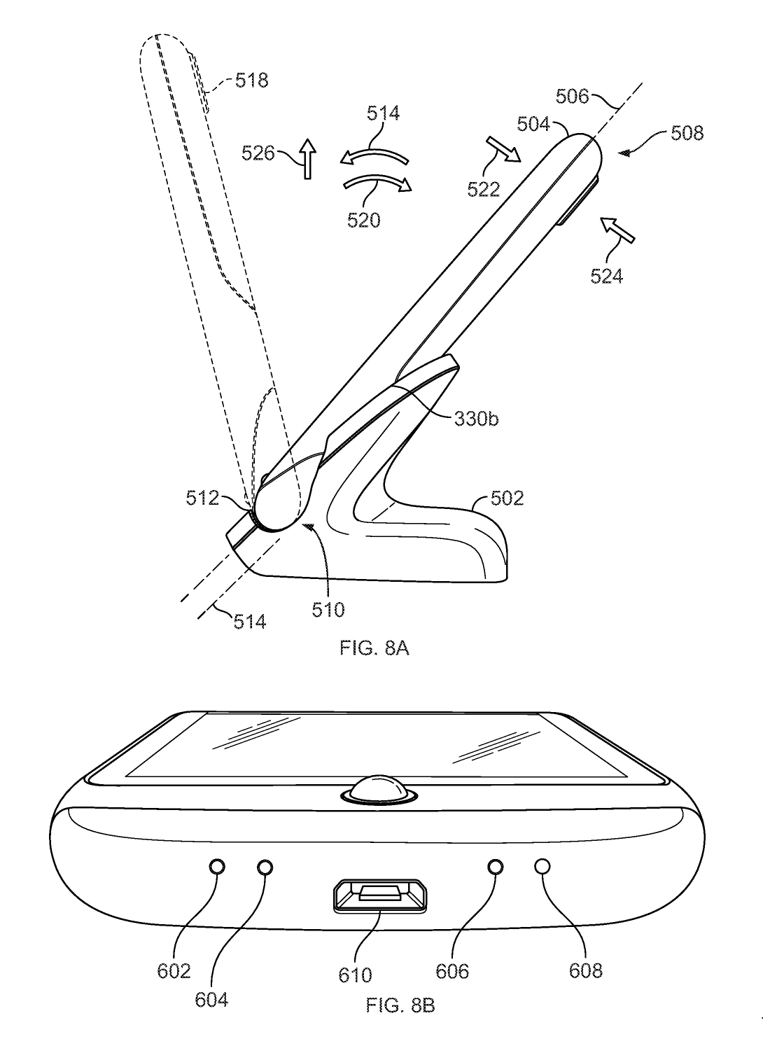

In general, the docking station may have any appropriate shape or size as long as the docking station is operable to receive and electrically couple with a mobile computing device. FIGS. 7 and 8A show additional structural features that may be included in any of the wall-mounted docking stations discussed herein, for example, and will be described below.

Each of FIGS. 2A and 2B shows a docking station 120 in which a mobile computing device is not docked in the docking station 120. In some implementations, light switch 101 may be accessible for actuation by a user when a mobile computing device is not docked in the docking station 120. That is, a user may actuate the actuation element 112 of the light switch 101 to alter an illumination state of one or more lighting elements 110. For example, as a user enters the room 104, the user may locate the light switch 101 in the expected location, and may actuate the actuation element 112 of the light switch to cause an illumination state of the light 110 to be altered independent of the docking station 120.

In some implementations, when the actuation element 112 of the light switch 101 is actuated, docking station 120 receives an input indicative of the actuation. If a mobile computing device is not currently docked in the docking station 120, as depicted in FIGS. 2A and 2B, the docking station may cause or permit an illumination state of the lighting element 110 to be altered based on the actuation of the light switch 101.

FIG. 2C shows the docking station 120, and shows an example mobile computing device 130 that is docked in the wall-mountable docking station 120. As can be seen in FIG. 2C, the docked mobile computing device 130 is disposed in front of the light switch 101. In some examples, the light switch 101 is inaccessible for actuation by a user when the mobile computing device 130 is docked in the docking station 120. For example, the docked mobile computing device 130 may obscure or cover the light switch 101, making it inaccessible to a user without first undocking the mobile computing device 130. In some implementations, a mobile computing device docked in the docking stations 120a-f depicted in FIGS. 4A-4F may similarly obscure or cover the light switch 101.

Mobile devices 130 frequently include a touch-sensitive display screen (touch screen) 131, and can receive a user input via the touch screen 131 and cause an action to occur in response to the received input. In some implementations, a user may touch or tap the touch screen 131 of the docked mobile computing device 130, and in response, the mobile computing device may cause an illumination state of the one or more lighting elements 110 to be altered. That is, a touch or tap on the touch screen 131 of the mobile computing device 130 when the device is docked in the docking station 120 may have the same effect as an actuation of the actuation element 112 of the light switch 101 when a mobile computing device is not docked in the docking station 120. In some examples, a user input at the touch screen 131 of the mobile computing device 130 may cause a cause an illumination state of the one or more lighting elements 110 to be altered even when the mobile computing device is not docked in the docking station. For example, the mobile computing device 130 may communicate with the docking station wirelessly using a short-range communications protocol such as Bluetooth, near field communications (NFC), Wifi, or others when the mobile computing device 130 is within a proximity of the docking station. In some examples, a user interface of the mobile computing device may display a light control (e.g., one or more buttons, toggle switches, slider controls, or the like) when the mobile computing device is within a proximity of the wall-mounted docking station, so that a user may use the provided control(s) to alter an illumination state of the one or more lighting elements 110. In various implementations, either the docking station or the mobile computing device may detect that the mobile computing device is within the proximity of the docking station, for example. In some cases, upon detection that the mobile computing device 130 is within the proximity, the user interface of the mobile computing device may be changed to display the control(s) described above.

In some implementations, mobile device 130 presents a user interface that does not include any characters, icons, symbols, or the like on the display screen 131 when the device 130 is docked in the docking station 120, as shown in FIG. 2C. In some implementations, the mobile computing device may present a user interface that includes a lighted screen when the device 130 is docked in the docking station 120, which may indicate that the device is charging, and may indicate that a touch input received at the screen 131 may cause an illumination state of the lighting element 110 to be altered. Various illumination intensities for the screen 131 are possible, and in some examples, an illumination intensity of the screen 131 may correspond to a current illumination state for the lighting element 110, for example.

In some examples, the mobile computing device 130 may present a user interface that includes an unlit (dark) screen when the device 130 is docked in the docking station, but may still be responsive to a touch input received at the touch screen 131, and in response may cause an illumination state of the lighting element 110 to be altered.

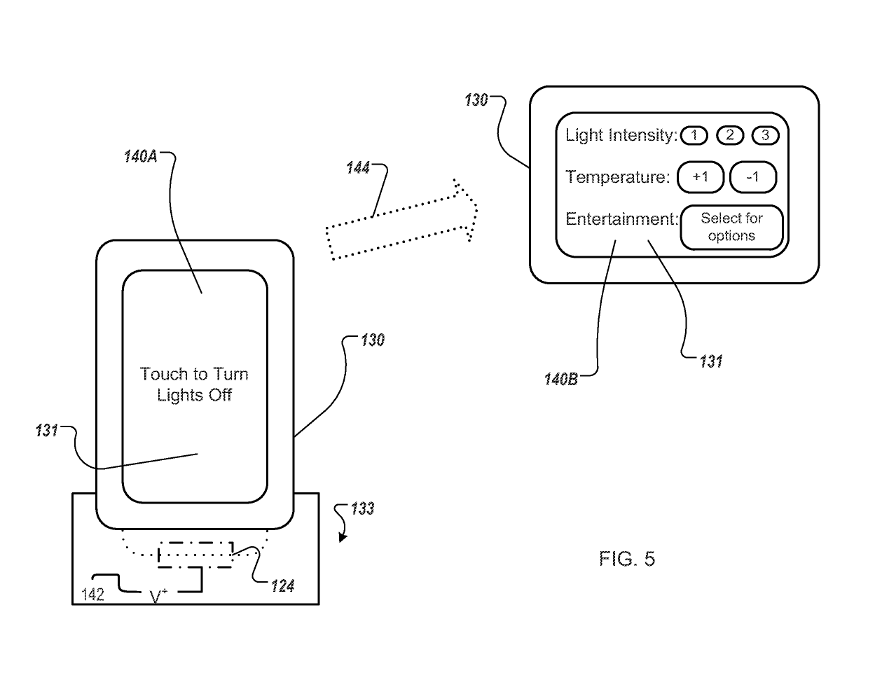

In some implementations, mobile device 130 presents a user interface that includes a message on the screen 131 when the device 130 is docked in the docking station 120. In some examples, the message may provide an instruction and/or an indication of an action that may be performed if an instruction is followed. FIG. 5 depicts a mobile computing device 130 representatively docked in a docking station 133, which may represent any of the docking stations discussed herein, and depicts a “Touch to Turn Lights Off” message displayed on the screen 131 of the device. The message may inform a user that if the user touches the touch screen 131 of the device 130 (or touches in a certain area, where touching in other areas may invoke other functions, such as control of a music system), the device 130 will cause a light or lights in the room to be turned off. Such a message may be displayed, for example, when the light or lights in the room are currently illuminated.

In some examples, the messages may include icons, images or animation. For example, an image of a light bulb may be displayed on the screen 131, and may be displayed with or without accompanying descriptive text. In examples in which the image is displayed without accompanying text, the image alone may inform a user that touching the screen of the device may cause an illumination state of the room lights to be altered. As another example, an animation sequence that depicts a finger touching a screen of a docked mobile device and then depicts an illumination state of a light changing may be presented on the screen of the device.

Similarly, the device 130 may display a “Touch to Turn Lights On” message, or similar, on the screen 131 of the device 130 when the device 130 is docked in the docking station. Such a message may inform a user that if the user touches the touch screen 131 of the device 130, the device 130 will cause a light or lights in the room to be turned on. Such a message may be displayed, for example, when the light or lights in the room are currently not illuminated. Messages that include icons, images or animation that inform a user how to turn the lights on may similarly be presented on the screen 131 of the device 130.

In examples in which a light switch may assume more than two illumination states, an input received at the screen of a docked device may similarly cause the illumination state to be altered. For example, a single tap or touch received when the lighting element 110 is illuminated may cause the lighting element 110 to turn off, while two or more received taps or touches (e.g., within a predetermined time period) may cause an illumination state of the lighting element 110 to be increased or intensified. In some cases, an illumination intensity may be increased by an amount based on the number of taps or touches received within a time period, for example.

In some implementations, the mobile computing device 130, when docked, may not completely obscure or cover the light switch 101. For example, with some implementations of docking stations 120 and 120a-f, and/or implementations of an associated mobile device, the mobile device when docked may not completely obscure or cover light switch 101. With some examples of such implementations, an actuation of actuation element 112 may not cause an illumination state of the lighting element 110 to be altered. For example, the docking station may receive an input indicative of the actuation, and because mobile computing device 130 is currently docked and may be receptive to an input to alter an illumination state, the docking station may not cause or permit an illumination state of the lighting element 110 to be altered based on the actuation of the light switch 101. Alternatively, the mobile computing device 130 may receive, via the docking station 120, the input indicative of the actuation, and may not cause or permit an illumination state of the lighting element 110 to be altered based on the actuation of the light switch 101. As such, the actuation of the light switch 101 may be ignored or bypassed in some examples. In other implementations in which the mobile computing device 130, when docked, does not completely obscure or cover the light switch 101, an actuation of actuation element 112 may cause an illumination state of the lighting element 110 to be altered (e.g., as caused or permitted by the docking station or mobile device).

A physical docking connector 124 may engage a mating connector on the mobile computing device 130 when the device 130 is docked. The docking connector 124 may be of any appropriate type, and may be adapted to supply electrical power to the mobile computing device 130. When docked, for example, the mobile computing device 130 may recharge one or more batteries of the mobile computing device 130 using the provided electrical power from the docking connector 124.

In some implementations, the mobile computing device 130 may inductively couple with the docking station. For example, the mobile computing device 130 and the docking station may establish a wireless, electromagnetic field connection, where the connection is used to transfer energy from the docking station to the mobile computing device 130 to charge one or more rechargeable batteries on the mobile computing device 130. In some examples, the inductive connection may facilitate signaling or communication from the docking station to the mobile computing device, from the mobile computing device to the docking station, or in both directions. In some examples, a universal standard for inductive charging, such as the “Qi” system established by the Wireless Power Consortium, may be used.

A dock detector, which may be included on the mobile computing device 130, on the docking station, or both, in some implementations, may detect when the device 130 is docked in the docking station. In some examples, the dock detector may sense one or more of a voltage, a current, or a physical contact (e.g., one or more connector pins), associated with the docking connector 124 or a connector on the mobile device 130, and may determine in response that the mobile device 130 is docked in the docking station.

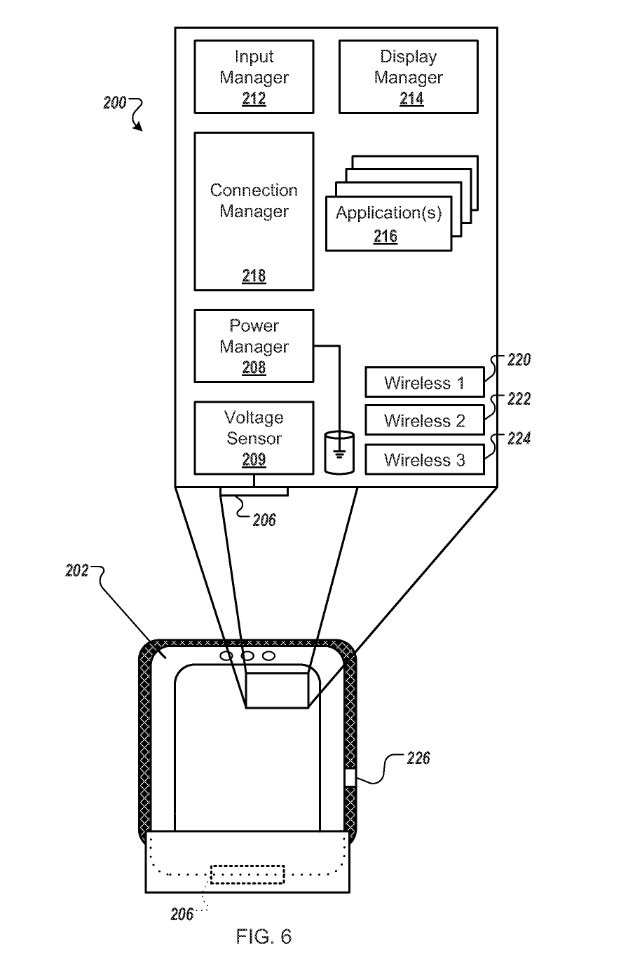

In some implementations, a dock detector on the mobile device 130 may determine that the docking station 120 is a particular type of docking station. For example, the docking station 120 may include a near field communications (NFC) chip or tag that may identify the docking station 120 as a first type of docking station. When the mobile device 130 is brought within a close proximity of the docking station 120, the dock detector may receive a communication from the NFC chip, for example, and the communication may identify the docking station 120 as a first type of docking station. In other examples, various radio-frequency identification (RFID) techniques may be used. In various implementations, communications may be one-way from the docking station 120 to the mobile device 130, or may be two-way between the docking station 120 and the mobile device 130. In some implementations, the dock detector may detect that the docking station 120 is a particular type of docking station in other ways. For example, a Bluetooth communication or other type of wireless or wired communications may be received, or a particular pattern of physical connector pin or pins may be detected when the device is docked, to list just a few examples. One or more of these identifying elements associated with the docking station is indicated by identifier 226 in FIG. 6, where the element 226 is representatively shown toward the right side of the docking station in FIG. 6, but could be at any appropriate location on the docking station (e.g., at or associated with the docking station connector).

In some implementations, a mobile computing device 130 may present a first user interface on a display screen of the device 130 when the device 130 is docked in the docking station 120, and may present a second user interface that is different from the first user interface on the display screen when the device 130 is not docked in the docking station 120. In some examples, the user interface provided when the mobile computing device 130 is docked in the docking station 120 may be a simplified version of the user interface provided when the mobile computing device is undocked. For example, the user interface provided when the mobile device 130 is docked in the docking station 120 may provide a subset of the functionality provided by the user interface when the mobile device 130 is undocked.

In some implementations, the docking station 120 includes a housing 122 that can include one or more mechanical features that receive and/or secure the mobile computing device 130 in a docked position. The one or more features may include connector 124, for example. In some implementations, the one or more features that receive and secure the mobile computing device may include one or more slots running vertically along a left wall and a right wall of the housing 122, where the slots can accept and guide the left and right edges, respectively, of the mobile computing device 130 as the device is slid into the docking station 120. In some implementations, the housing 122 may include a base tray that supports a lower edge of the mobile computing device 130 when the device is docked. In other examples, one or more securing features such as locating pins or clamps may be used. In some implementations, the dock may include one or more magnets that may help position and retain device 130 in the docking station.

In some examples, the housing 122 may extend from about 0.3 inches to about 1.0 inches from the wall 102, or far enough to extend beyond the actuation member 112 of the light switch 101 (and enough that the docked device can lean backward toward the wall slightly, rather than being vertical or leaning forward away from the wall). A portion of the housing 122 may be partially disposed within a recessed cavity or pocket of the wall. In some implementations, a forward-facing edge of the mobile computing device 130 (e.g., the display screen) may be approximately flush with a forward-facing edge of the housing 122 when the mobile computing device 130 is docked. In some implementations, the forward-facing edge of a docked mobile computing device 130 may extend slightly beyond the forward-facing-edge of the housing 122. In some implementations, the forward-facing edge of a docked mobile computing device 130 may be slightly recessed with respect to the forward-facing-edge of the housing 122. In some examples, the mobile computing device 130, when docked, may sit within an area defined by the housing 122, and in other examples a portion or all of the device may be outside of an area defined by the housing 122 when the device is docked. In some examples, the device, when docked, is located in front of the housing 122.

FIGS. 3A, 3B and 3C show an example implementation in which a docking station 132 is positioned adjacent the light switch 101 on the wall 102. In some implementations, docking station 132 may be substantially similar to docking station 120, except that it may be located adjacent to light switch 101 rather than surrounding the switch 101. In the depicted examples, the docking station 132 is positioned to the right of light switch 101, but in other examples the docking station could be positioned to the left of light switch 101, or above or below light switch 101. Any of the various docking station styles discussed above with reference to FIG. 2A-2C or 4A-4F may similarly be represented by station 132.

Each of FIGS. 3A and 3B shows a docking station 132 in which a mobile computing device is not docked in the docking station 132. In some implementations, the light switch 101 may be accessible for actuation by a user when a mobile computing device is not docked in the docking station 132. That is, a user may actuate the actuation element 112 of the light switch 101 to alter an illumination state of one or more lighting elements 110. For example, as a user enters the room 104, the user may locate the light switch 101 in the expected location, without regard to the docking station 132, and may actuate the actuation element 112 to cause an illumination state of the light 110 to be altered.

FIG. 3C shows the docking station 132, and shows a mobile computing device 130 that is docked in the wall-mountable docking station 132. In some examples, the light switch 101 is inaccessible for actuation to cause a change in illumination state when a mobile computing device 130 is docked in the docking station 132. In other examples, the light switch 101 may be accessible for actuation to cause a change in illumination state when the mobile computing device 130 is docked in the docking station 132, so that actuation of the actuation element 112 alters an illumination state of lighting element 110.

FIG. 5 shows schematically a system in which a wired electrical connection is made between the mobile computing device 130 and the docking station 133 when the device is docked (e.g., between a connector on the device and the docking connector 124). For simplicity, the housing of the docking station 133 is not shown in FIG. 5. In some implementations, the formation of the electrical connection triggers other actions on the device 130 to occur. FIG. 5 also shows the device 130 being removed 144 from the docking station 133 (or undocked), which causes the wired electrical connection to be broken. In some implementations, breaking the electrical connection triggers other actions on the device 130 to occur.

A first device state 140A of the mobile device is shown when the device 130 is physically connected to the docking station 133, and a second device state 140B is shown when the device 130 has subsequently been undocked. A charging mechanism is shown schematically in the figure by supply voltage 142 that is provided through a physical docking connector 124 to recharge batteries in the device and to allow the device to operate when it is docked. In some implementations, the docking station also has a display that can show a time, or status relating to the docking station, including via information that is received from the device.

As can be seen in FIG. 5, the first device state 140a include presentation of a first user interface on the screen 131 of the device when the device is docked, and the second device state 140b includes a presentation of a second user interface on the screen 131 of the device when the device is not docked. The first user interface, presented when the device is docked in the docking station, may be associated with a limited feature set of the mobile computing device 130 as compared to the second user interface, which may be associated with a larger or full feature set of the device and may be presented when the device is not docked in the docking station.

When docked, the device 130 may present a user interface that may be responsive to one type of input (e.g., a received contact on the touch screen 131), and may respond to the input by causing one action or a series of actions to occur. The action or series of actions may be dependent on an operating state of the device or of features associated with the device. For example, when the room lights are on, the docked device may present a “Touch to Turn Lights Off” message, as shown in FIG. 5. When a contact with the screen 131 is received, the device 130 may send a command that causes the room lights to turn off. The device 130, still docked, may then present a different message on the screen, such as “Touch to Turn Lights On,” for example.

In some examples, the docked device 130 may be responsive to a small number of input types (e.g., one, two, three, or the like). For example, receipt of an input that swipes across the screen 131 in an upward direction may cause an illumination intensity of the room lights to be increased. Conversely, receipt of an input that swipes across the screen 131 in a downward direction may cause an illumination intensity of the room lights to be decreased. In some examples, an amount of increase or decrease may be based on a speed of the swipe, a length of the swipe, or both. As described above, multiple touches or taps within a predetermined period of time may also cause certain actions to occur.

In some examples, when undocked, the device 130 may present a user interface that may be responsive to several types of input, and the presented second user interface may correspond to more full-featured device capability as compared to the first user interface that is presented when docked. In FIG. 5, the undocked device is shown presenting a user interface that permits light intensity to be adjusted to one of three levels, permits room temperature to be adjusted upwards or downwards by a predetermined amount (e.g., one degree), and permits selection of an entertainment option, which may cause another display of entertainment options to be presented (e.g., volume adjust for an entertainment system, device selection among various entertainment devices, play/pause/forward/rewind options, track or episode selection options, and the like).

FIG. 6 is a schematic diagram 200 of a docked mobile computing device 202. An input manager 212 in the device manages input to the device, including touch input to a screen on the device. A display manager 214 coordinates with the touch manager and controls what items are displayed in what positions, which will be shown over other items, and which will be shown as having the device's focus.

A connection manager 218 manages docked and wireless connections for the device, such as in the manners discussed above. For example, the connection manager 218 may infer a context for a device based on the manner in which it is docked, and may notify various applications 216 that may be run on a processor of the device 200 of the device context. A power manager 208 and voltage sensor 209 cooperate to determine when a device has been plugged into a power source, and also to determine when certain activities may occur on a device after it has been plugged in. A physical connection 206 is representatively shown between a connector of the device and a connector of the dock. Various wireless interfaces 220-224 may be employed by the device 200 in order to communicate by a variety of modes, in some implementations, such as BLUETOOTH, WiFi, 3G, 4G and other cellular connections.

In some examples, each room in a house may include a wall-mounted docking station of one of the types discussed above, where each of the wall-mounted docking stations may be associated with one or more lighting elements (e.g., a specific light or a set of lights) within the particular room. In some implementations, two or more, or all, of the wall-mounted docking stations may have the same type or model number, and each may be associated with a specific lighting element or set of lighting elements, such that when a mobile device is docked therein, the lighting element (or set) may be controlled, as discussed herein.

Each of the docking stations may be adapted to supply power to a mobile computing device and cooperate with a wall-mounted light switch. In various implementations, the wall-mountable docking stations may work in concert with the mobile computing device and a wall-mounted light switch to provide enhanced functionality. When a mobile computing device is docked in a particular docking station, the device may recognize the type of docking station, and may present a user interface based on the recognized type of docking station.

In some examples, the device may associate the recognized type of docking station with a particular feature set for the docking station, the associated room, or an environment associated with the docking station, and may present a user interface based on the particular feature set. For example, the device may recognize a particular docking station as being associated with a room that includes four separate lighting elements (e.g., two overhead and separately addressable lighting elements, one table lamp, and one floor-standing lamp). When docked, the device may present a user interface that permits altering an illumination state of any of the four lighting elements based on one or more received inputs. When undocked (e.g., after having been previously docked within the room), the device may present an expanded or enhanced user interface that offers more functionality versus the user interface presented when the device was docked. For example, in addition to providing lighting control for the various lighting elements, the device may offer one or more of temperature control, control of various entertainment options within the room, communications functionality (e.g., e-mail, text message, telephone service, web browsing, and the like), and others, such as access to any of the applications associated with the device, which may be restricted, inaccessible, or limited when the device is docked, for example.

In some implementations, for a given installation of docking stations throughout an environment (e.g., throughout a house), one or a small number (two, three, e.g.) of mobile computing devices may be included for a larger number of docking stations (e.g., ten wall-mounted docking stations for a house with ten rooms). In some examples, a number of mobile devices may match a number of docking stations, such as in examples in which each room of a house generally includes a mobile device. The number of mobile computing device may also be less than the number of docking stations, such as when a consumer does not care to purchase a full number of devices and is willing to move a smaller number of devices throughout a home. Alternatively, the number of mobile computing devices may exceed the number of docking stations, such as when a home owner wants a device at every station, and also wants several devices to carry around the home.

In various implementations, the mobile computing devices discussed herein may be docked in docking stations of types other than the wall-mounted docking stations discussed above. For example, some docking stations may be associated with particular appliances, systems, or sub-environments, and docking the mobile device in the corresponding docking stations may cause the mobile device to present a user interface appropriate for the corresponding appliance, system, or sub-environment.

FIG. 7 shows an example desktop docking station for a mobile computing device. This figure shows the desktop docking station 302 in both a front view 302A and a rear view 302B. In this example, the docking station 302 is adapted to receive audio and data signals from a mobile device, and to pass the audio and data signals on to other devices, in some implementations. As illustrated in the front view 302A, the docking station 302 is adapted to receive a mobile computing device 304 when the dock 302 is resting on a flat surface.

In some examples, the docking station 302 may include three conductive pins for establishing physical electrical connections with the device 304, when it is docked. A first pin 306 may provide a positive voltage electrical current to the device 304. A second pin 308 may provide a reference voltage (e.g., ground) to the device 304. A third pin 310 may be used for bi-directional serial data communication between the dock 302 and the device 304. Additional pins may be included in other implementations, such as to provide for parallel data communications with the device 304.

In some implementations, the wall-mounted docking stations discussed herein may include similar interface connections, in a similar or alternative form factor, as those shown in FIG. 7. For example, any of docking stations 120, 120a-f, 132, 133 may include a three conductive pin interface as shown in FIG. 7. Additionally, the housings discussed herein may include some of the mechanical features associated with the docking station 302 of FIG. 7. For example, and the housings 122, 122a-f, 134 may include a cradle mechanism similar to the docking station 302 shown in FIG. 7. Generally, mobile devices of various styles are shown in the various figures to provide representative examples of different device styles, sizes, interface types, and so on, which may be used.

As illustrated in the back view 302B, the example docking station 302 includes a 3.5 mm female audio output jack 320, and a female USB jack 322. A 3.5 mm to RCA cable 324 or other type of interface connector may connect the docking station 302 to an external appliance 328 (e.g., a receiver of a home stereo system). A USB cable 326 may connect the docking station 302 to a power brick for connection to an AC power source. In some examples, the USB cable 326 may connect to a DC power source without a power brick, for example by connecting to a laptop computer. The laptop computer may supply solely DC power to the docking station 302, or may additionally establish digital data communications with the docking station 302.

In some implementations, wall-mounted docking stations may be powered by one or more power signals derived from a standard power signal (e.g., 120V, 60 Hz, AC signal in the U.S.) available via the electrical wiring system of the house, office building, or the like. Because the wall-mounted docking station may be mounted near a light switch, such a signal may be readily available, for example. In various implementations, the docking station may include conversion circuitry, such as an AC-DC converter and optionally one or more DC-DC converters, to convert the standard power signal to one or more appropriate direct current voltages for powering the docking station and mobile computing device, for example, and for charging the mobile computing device.

Accordingly, and as described in more detail throughout this document, the docking station 302 may power a device 304 that has been placed in the docking station 302, and may recharge a battery of the device 304. While docked, the device 304 may provide audio or data transmissions to the docking station 302, which the docking station 302 may route such transmission to an external audio source (e.g., appliance 328) or to a device adapted to receive data signals (e.g., another type of entertainment device, or a service device). The audio transmissions may be transmitted wirelessly between a radio transceiver in the device 304 and a radio transceiver in the docking station 302, in some examples. In some implementations, the pin 310 that is used for serial communication may be used to initiate the wireless communication, but may not be used to execute subsequent data communication between the docking station 302 and the device 304 (e.g., to subsequently transfer data that represents an audio signal). In some implementations, data interface between the device 304 and the docking station may be over a wired connector.

In some implementations, the docking station (e.g., station 302 or any of the wall-mounted docking stations discussed herein) may communicate with other devices or appliances by wired or wireless connection. For example, the docking station may communicate with one or more lighting elements, one or more entertainment devices or systems, one or more service devices or appliances (e.g., refrigerator, oven, dishwasher, washing machine, dryer, microwave, thermostat, humidity control system, security or alarm system, or the like), or even with one or more other docking stations, via wired or wireless connection. In various implementations, the user interface presented on the mobile device when docked may include functionality to control one or more of the foregoing.

FIG. 8A shows a partially transparent view of a docking station (or a portion of a docking station) in which a mobile computing device has been placed. The docking station 502 may be the desktop docking station 302 that is illustrated in FIG. 7, or may represent a portion of one of the wall-mounted docking stations discussed herein.

The mobile computing device 504 may be docked into the docking station 502. A docked device 504 may be a device that has been placed by a user into a recess of the docking station 502 that is shaped to correspond to at least a portion of an outside of a housing for the device 504. In some examples, the device's conductive pads 602, 604, and 606 (see FIG. 8B) electrically contact the dock's conductive pins 306, 308, and 310 (see FIG. 7) when the device 504 is docked. When docked, the conductive elements in each dock may remain in contact without continued user assistance. Each conductive pad may be electrically isolated from each other, and each conductive pin may be electrically isolated from each other.

In some examples, the conductive pins 306, 308, and 310 are pins that are biased by springs toward the recess in the dock. When the device 504 has been docked, the conductive pads 602, 604, and 606 engage the pins 306, 308, and 310. The pins may be rods that are substantially cylindrical along a length of the pins and that are rounded at the end of the pin that contacts the respective conductive pads 602, 604, and 606. When docked, the device 504 may force the pins at least partially out of the cavity and into an internal portion of the docking station 502.

In some implementations, the docking station 502 is designed to receive the device 504 in a “frictionless” manner. In other words, a user may place and remove the device 504 from the dock 502 without applying much more force than is necessary to manipulate the device 504 in free space.

Accordingly, the docking station 502 might not include any guiderails or protrusions that engage with the device 504 and that cause the device 504 to be placed into the docking station 502, or removed from the docking station 502, with a one-dimensional linear movement. For example, a proximal end 510 of the mobile device (e.g., an end that is closest to the docking station 504 along a longitudinal axis 506 of the mobile device) may be placed into a lower portion of the recess as the mobile device is being docked, so that the longitudinal axis 506 of the mobile device remains substantially parallel to a longitudinal axis 514 of a rear face 328 of the docking station.

In another example, the proximal end 510 of the mobile device 504 may be positioned in a lower portion of the cavity so that a longitudinal axis 506 of the mobile device 504 is not substantially parallel with the longitudinal axis 514 of the rear face 328 of the docking station 502 (e.g., as in the position 518). In this example, the distal end 508 of the mobile device 504 may be pivoted (e.g., as illustrated with arrow 520) in order to place the mobile device 504 in a resting dock position. Upon pivoting, the longitudinal axis 506 of the mobile device 504 may be moved into a substantially parallel relationship to the longitudinal axis 514 of the face 328 of the docking station 502.

The docking station 502 may include a rear race 328, side walls 330a and 330b, and a lower retaining wall 332. The side walls 330a-b may cover a portion of the side walls 516 of the mobile device 504. The lower retaining wall 332 may include a lip 512 that does not substantially cover a front portion of the mobile device 504, and which may not cover any user input or user output devices on the mobile device 504. The lip 512 may rise enough to retain the device 504 in the docking station 502 when the device has been docked.

In some examples, a user lifts the device 504 in a vertical direction 526 out of the docking station 502. In such examples, the device 504 may be removed from the docking station with little apparent friction. For example, the docking station 502 may not frictionally engage the device 504 as the device is removed, beyond frictional contact forces that may be present when a device is vertically removed from a surface (e.g., frictional forces that may be apparent when a device is vertically removed from a flat table).

The docking station 502 may include three electrical pins 306, 308, and 310 that contact the device 504, and the device 504 may include corresponding electrical pads 602, 604, and 606. The electrical pads 602, 604, and 606 may each include a surface that is substantially flush with a surface of the exterior of a housing of the mobile device 504. For example, a substantially flush surface may sit no more than 0.5 mm above or below an outermost adjacent exterior surface of the device 504.

The mobile device 504 may include a female data connection terminal 610 on a bottom of the device 504. In some examples, the docking station 502 may not include a corresponding male data connection terminal. Thus, the mobile device 504 may include a data terminal that is oriented for exchange of data with the docking station 502, while the docking station 502 may not include a corresponding terminal. In other examples, the docking station 502 may include a corresponding male data terminal connection terminal, and may communicate with the device 504 over the data terminal.

In some implementations, the docking station 502 may not include components that engage, on the device 504, a surface of the device 504 that is internal to the device and that is parallel to the longitudinal axis 506. For example, if the docking station 502 included a male data connection terminal that mated with the female data connection terminal 610, side walls of the male connection terminal may frictionally engage with the side walls of the female connection terminal 610. In contrast, pin 306, for example, contacts the conductive pin 602 in an orthogonal manner. Thus, the pins 306, 308, and 310 and the conductive pads 602, 604, and 606 may not prevent the mobile device 504 from laterally moving in a direction that is orthogonal to the dock's longitudinal axis 506 or the axis 328 of the dock (even if another portion of the dock may prevent such lateral movement). Instead, a proximal portion 510 of the mobile device may be able to move in a direction that is orthogonal to a direction of compression of the pins 306, 308, and 310, while the mobile device 506 is in contact with the pins 306, 308, and 310. A frictional force of a pin sliding across a face of a conductive pad is not a substantial frictional force.

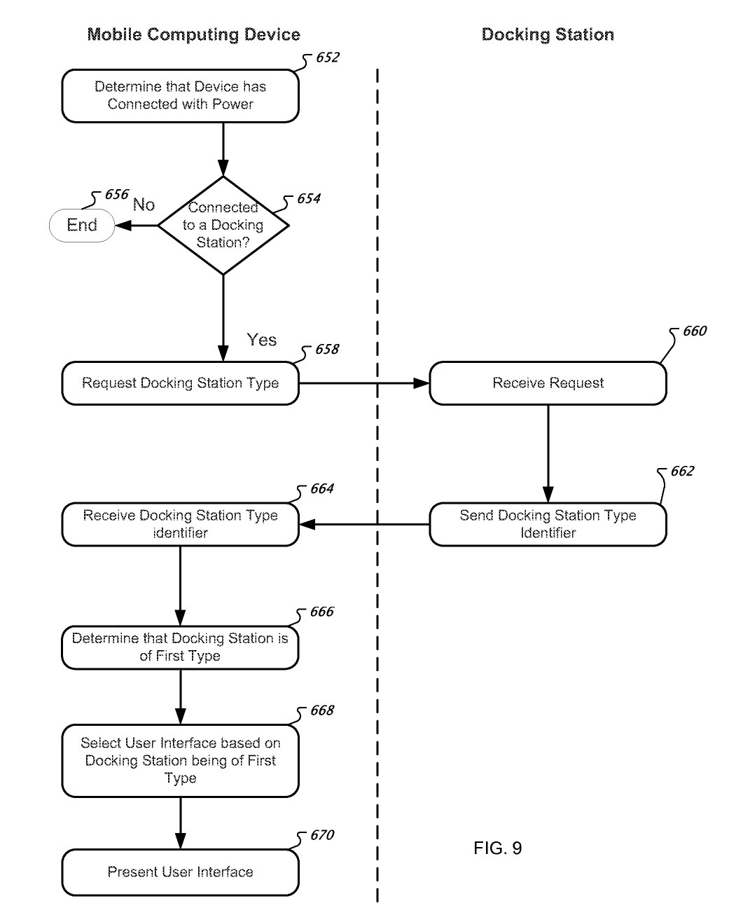

FIG. 9 shows a flowchart of an example process for identifying a docking station that a mobile computing device has physically mated with, and for presenting an appropriate user interface. The described actions may occur upon a user physically placing the mobile device into a docking station, for example, as illustrated in FIG. 7 (i.e., the placement of device 304 into docking station 302) and FIG. 8A (i.e., the placement of device 304 into docking station 502).

In box 652, the mobile computing device determines that the device has connected with electrical power. For example, the device may receive an indication that the device has begun to charge, or may receive an indication that voltage is present on an electrical bus that provides power for charging the device. As an illustration, the mobile computing device that is illustrated in FIG. 8B may determine that the device has been connected to electrical power when power is received at conductive pad 602.

In box 654, the mobile computing device determines whether the device is connected with a docking station. For example, the mobile computing device may determine whether a voltage of the conductive pad 606, which may normally be pulled up to a first voltage level when the mobile device is not connected to a docking station, has been pulled down to a second voltage level as may occur when the conductive pad 606 is electrically connected with pin 310.

The mobile computing device may perform the operations of boxes 652 and 654 separately because the mobile device may be unable to determine a source of the power (e.g., whether the power is being received through the data terminal 610 or through the conductive pad 602). In various examples, the determinations of boxes 652 and 654 are performed in a single step. In other words, the mobile device may be able to determine, when power is connected, whether the source of the power is through the data terminal 610 or is through the conductive pad 602. If the mobile device is not determined to be connected to a docking station, the process ends (box 656).

In box 658, the mobile computing device transmits to the docking station a command that requests that the docking station respond with the docking station type. In some examples, the command is transmitted over a single wire interlace, for example, from the conductive pad 606 of the mobile device to the pin 310 of the docking station.

In box 660, the docking station receives the request. In response, the docking station may access a stored alphanumeric identifier which identifies the docking station type, and may transmit the docking station type alphanumeric; identifier back to the mobile device (box 662). In various examples, docking station 302 and docking station 402 would each respond with a different identifier, but multiple of the same type of docking station may respond with the same identifier. In box 664, the mobile computing device receives the docking station type identifier.

The device, at box 666, uses the identifier to determine that the docking station is of a first type. For example, the device may use the identifier to determine that the docking station is a wall-mountable docking station mounted in proximity to a wall-mounted light switch. As another example, the device may determine that the docking station is associated with an appliance. As another example, the device may determine that the docking station is associated with an entertainment system. As another example, the device may determine that the docking station is associated with a sub-environment, such as a kitchen countertop sub-environment, a family room coffee table sub-environment, a bedroom nightstand sub-environment, or a garage workbench sub-environment.

At box 668, the device may select a user interface based on the docking station being of the first type. For example, in the case of the wall-mounted docking station mounted in proximity to a wall-mounted light switch, the device may select a user interface that provides lighting element illumination adjustment functionality, such as the user interfaces depicted at FIGS. 2A, 2C, and 5, and as discussed above. In the case of the docking station associated with an appliance, the device may select a user interface that provides appliance control functionality, for example. In the case of the docking station associated with an entertainment system, the device may select a user interface that provides control functionality for the entertainment system, for example. In the case of docking station associated with the kitchen countertop sub-environment, the device may select a user interface that provides a list of recipes or a grocery shopping list, for example. In the case of the docking station associated with a family room coffee table sub-environment, the device may select a user interface that provides television schedules or other entertainment listings, for example. In the case of the docking station associated with a bedroom nightstand sub-environment, the device may select a user interface that provides alarm functionality or calendar functionality, to list just a couple examples. In the case of the docking station associated with a garage workbench sub-environment, the device may select a user interface that provides auto repair instructions, or lawn care instructions or schedules, to list just a couple examples.

At step 670, the device presents the user interface on a display screen of the device. In general, the user interfaces presented while the device is docked in the docking station may be minimalist user interfaces, and may be much simpler than corresponding user interfaces that the device may present when not docked in the docking station. For example, the device may be responsive to a simple touch anywhere on the touch screen of the device, and may cause a particular action to occur in response. In some cases, the user interface may include a blank or null presentation on the display screen of the device, though the device may nevertheless be responsive to touch inputs on the screen and may cause an action to occur in response (see, e.g., FIG. 2C and discussion related to FIG. 2C above).

In some examples, the mobile computing device may communicate wirelessly with the docking station. In some examples, such wireless communication may occur when the device is docked, and may also occur when the device is unlocked.

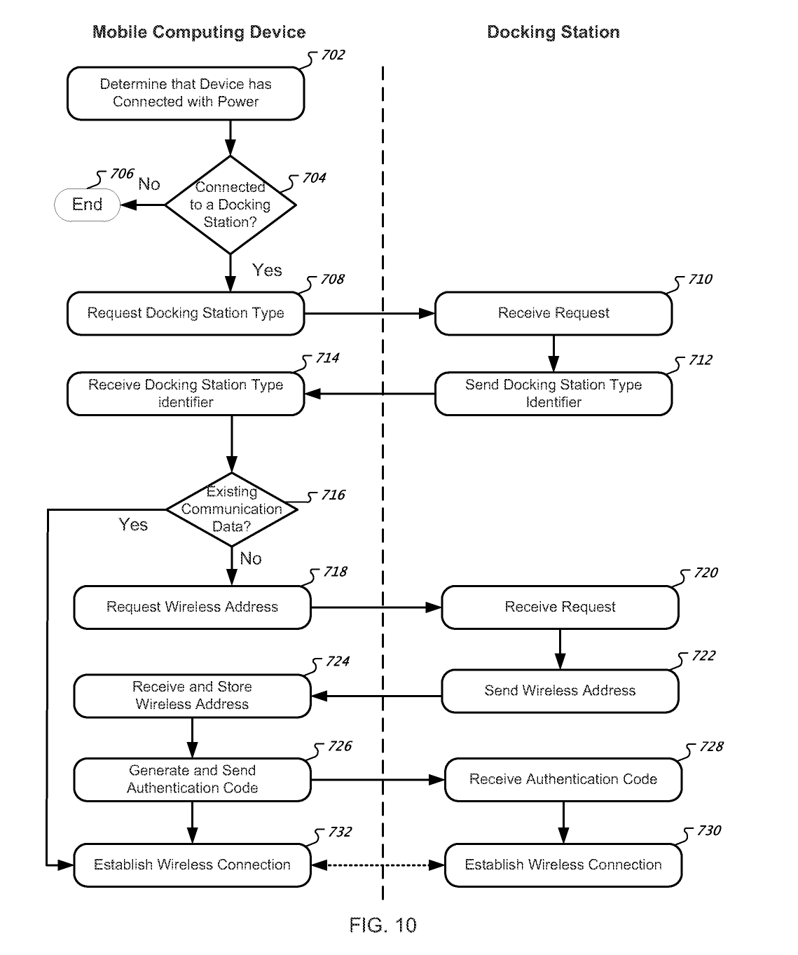

FIG. 10 shows a flowchart of an example process for identifying a docking station that a mobile computing device has physically mated with, and for establishing a wireless connection with the docking station. The described actions may occur upon a user physically placing the mobile device into a docking station, for example, as illustrated in FIG. 7 (i.e., the placement of device 304 into docking station 302) and FIG. 8A (i.e., the placement of device 304 into docking station 502). In various examples, the process describes an automatic BLUETOOTH pairing that occurs upon the mobile device determining the type of dock when upon docking.

Boxes 702-714 generally correspond to boxes 652-664 of FIG. 9, and will not be elaborated on here. The device, at box 716, uses the identifier to determine whether the device has previously stored data for establishing a wireless connection with the docking station (e.g., whether the device includes a wireless network identifier for the docking station and an authentication code for establishing the wireless connection). If the device has the stored data, the device may establish the wireless connection, as described with reference to box 732. If the device does not have the stored data, the device requests the wireless network identifier from the docking station (box 718).

In box 720, the docking station receives the request for the wireless network identifier. In response, the dock may access a stored alphanumeric identifier of a network address that the docking station may use for wireless communication, and may transmit the accessed network address back to the dock as the network identifier (box 722). In some examples, the network identifier is stored under the BD_ADDR variable and is a unique address of the dock as a BLUETOOTH device, similar to MAC addresses of a network card. This address may be used in pairing the mobile device and the docking station.

In box 724, the Mobile computing device receives and stores the network identifier. The mobile device may store the network identifier in association with the docking station type identifier, so that the mobile device may identify the network identifier upon subsequently docking with the docking station (and thus receiving the dock type identifier).

In box 726, the mobile computing device generates and sends an authentication code to the docking station. For example, a BLUETOOTH device may use a passkey or pin code in order to establish communication with another BLUETOOTH device. Thus, the mobile device may generate the authentication code, send the code to the other device, and may store the code in association with the docking station type identifier. The docking station subsequently receives the code (box 728).

Upon the mobile computing device and the docking station both having stored the code, the devices may establish wireless communication with each other. For example, with BLUETOOTH communication, the docking station may send the passkey back to the mobile device as an acknowledgment, and in response both device may wirelessly pair and exchange data. In various examples, the docking station may be configured to remain unable to wirelessly pair with any devices until the docking station has received a code from another device over a physical electrical connection. In various examples, the docking station wireless radio may remain off until the docking station receives the wireless code.

In various examples, the docking station generates the authentication code and transmits the code to the mobile device. In various examples, the docking station requests the wireless address from the mobile computing device. In various examples, the communication between the mobile computing device and the docking station is performed using Modified Frequency Modulation (MFM) and Run length limited (RLL) coding to ensure that the length of repeated bits during which a signal does not change is limited. In various examples, the mobile computing device and the docking station establish wireless communication through a third device, for example, a Wi-Fi router.

In various examples, a transmission by either the mobile device or the docking station starts with two “1” databits (0101 after MFM encoding, where “1” indicates a transition and “0” indicates a maintained output). Such a start allows the receiving device to synchronize on rising and falling edges, which may help avoid problems that are caused by a DC bias on the line, or problems that may be caused by a non-center switching threshold on the general purpose input/output.

In various examples, a device that is receiving data waits for an edge and measures the time from the last edge of the same polarity. An error is recorded if the edge occurs outside of a specified margin of error. Once the expected quantity of bits has been read, a validation may be performed to determine whether the received data represents a valid MFM encoded pattern.

In various examples, a device that is transmitting reads a hardware timer before and after toggling the output to generate an edge. If the difference in times is outside of an acceptable margin, the device stops transmitting. If there has been a delay in the code, the receiving device may detect that there was an error unless the error occurred during the last one or more bits of a byte or of a transmission sequence. Errors in the last bit may be caught by a checksum byte as an erroneous transmission may not be a valid MFM sequence. A known stop bit may be added to improve the error checking.

In various examples, all write commands are the same length and all read commands are the same length. Both read and write commands may begin with the mobile device sending the command followed by a short delay where the docking station takes control of the data line by driving the data line to the same voltage level that the mobile device left the line in. The docking station may immediately respond with a response. The response may include two start data bits followed by one acknowledgment data bit for a write command (e.g., box 726). The response may include two start data bits followed by 8 result data bits for read commands (e.g., boxes 708 and 718). In some examples, the docking station cannot initiate a command, and may only respond to commands by the mobile device.

In various examples, a separate command may be used to send or receive each byte of multi-byte data such as the wireless network identifier or authentication code. Another command may read or send a checksum byte. Breaking the communication into smaller portions may limit the time spent with device interrupts disabled.

In various additional examples, identification of a docking station type may occur in a variety of manners. For example, one or more electrical contacts may be provided on the device and at a corresponding location on the docking station. The number of electrical contacts that are made between the device and the docking station may be used to determine what type of docking station the device has been docked to. For example, where the device and docking station each have two contacts, the device could determine three different dock types, in which a first contact is made, a second contact is made, or both contacts are made (no contacts may have to be assumed to represent a device that is not built to the standard). The three types of docks in such an example may include a wall-mounted station that cooperates with a light switch, a docking station associated with an appliance or system, and a docking station associated with a sub-environment. Additional electrical contacts may provide for additional information to be determined by the mobile computing device when it is docked. The particular types and locations of contacts may be defined by a standard, so that the mobile device may be interoperable with docking stations made by a variety of suppliers. In a similar manner, magnets may be placed in the device and/or docking station, and attraction of the magnets to items placed in the opposite machine may be used to make determinations in a manner similar to that for the contacts just discussed.

In another implementation, the docking station identification may be communicated to the mobile computing device through a physical data connection between the docking station and the device. For example, the data connection may be parallel to or integral with the electrical connection between the device and the docking station, or the data may be superimposed over the electrical signal that is passed to the device. A digital representation may be provided to the device in this manner that identifies the type of docking station, and thus the context in which the mobile device has been docked.

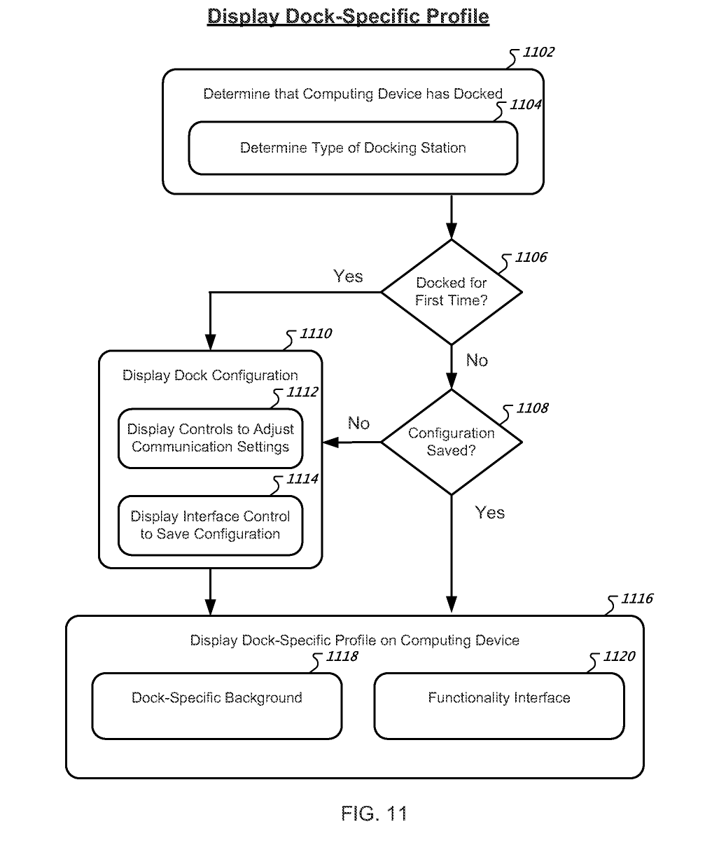

FIG. 11 shows a flowchart of an example process for displaying a dock-specific profile. In box 1102, a mobile computing device determines that the device has been docked, for example, by identifying that an electrical signal is being received from the dock. The determination that the device has been docked may include determining a type of the docking station (box 1104). The type of docking station may be determined based on a serial digital signal that the mobile device receives from the docking station. The dock determination operations are described in more detail throughout this document.

In box 1106, the mobile device determines whether the device has previously docked with the type of docking station. For example, the device, when docked, may store an indication that the device has docked. Thus, upon a subsequent docking, the mobile device can check to see if the indication is stored, and, if the indication is not stored, the device may determine that it has not previously docked with the type of dock docking station. In various examples, the indication is stored by the docking station and is transmitted to the mobile device upon docking. If the mobile device is being docked for the first time, the docking station configuration interface may be displayed (box 1110). In various examples, the indication identifies a type of the docking station, so that the configuration interface may be displayed only when a device is docked for a first time with a particular type of docking station, even though the device may have previously docked with other types of docking stations.

In box 1110, a docking station configuration user interface is displayed. In some examples, the configuration user interface is specific to the docking station. In other words, the mobile device may be configured to dock with multiple types of docking stations, and a different configuration interface may display for each docking station.

In box 1112, the configuration user interface displays user interface controls that enable a user to adjust communication settings between the docking station and the mobile device. In various examples, the user interface controls enable the user to activate settings for wirelessly transmitting specific types of information between the docking station and mobile device. For example, activation of a first setting may cause the mobile device to transmit to the docking system audio that is generated by one or more media player application programs. Activation of a second setting may cause the mobile device to transmit to the docking system audio that is received during a telephone call, and to receive from the docking system audio that a microphone in the docking system receives during a telephone call. Activation of a third setting may toggle whether the mobile device terminates a wireless connection with the dock upon undocking, or whether the wireless communication persists upon undocking.

In box 1114, the configuration user interface displays a user interface control for saving a current configuration (e.g., a current user activation of settings). Upon subsequent docking of the mobile device with the same docking station or type of docking station, the configuration user interface may not be displayed. Instead, the user interface may display without presentation of the configuration dialog box.

Accordingly, at box 1108, a determination is performed whether the mobile device should present a configuration display when the device has been docked, but the device is not being docked for a first time. If the configuration settings have not been saved, the configuration user interface may be displayed again. If the configuration settings have been saved, the configuration user interface may not be displayed.

Regardless, upon docking, a dock-specific user interface profile is displayed to a user (box 1116). The dock-specific user interface can include the display of the dock configuration user interface in the above-described circumstances (box 1110), and can also include a display of a dock-specific background (box 1118), and a functionality interface (box 1120), among various examples. In box 1118, the mobile computing device displays a dock-specific background. In some examples, a background is a display that is presented as a backdrop to a functionality interface. In some examples the dock-specific background and functionality interface may be merged.

The combination of the background and functionality interface is referenced herein as a mobile device “desktop.” The desktop may be a first display that is presented to a user upon docking a device, or upon acknowledging settings in a configuration screen. The desktop for a docked mobile device may be quite different than the desktop for an undocked mobile device, and in many cases may be much simpler or streamlined. The desktop may be a first display that is presented to a user upon turning the device on. The desktop may display upon user selection of a hardware button.

Accordingly, with respect to docking of a device, various actions are disclosed that may occur automatically (i.e., without user intervention) when a user docks their mobile computing device to a docking station. For example, the device can recognize an environment that is associated with the docking station and may change modes to match that environment.

The mode of operation of the device may change automatically in response to the device being docked. In general, the mode of operation may be changed so that the current mode of operation matches the environment or context in which the mobile computing device has been determined to of been placed.

For example, if the environment is determined to be a dock attached to a lighting system, the mode of operation may be changed by launching a lighting system control interface.

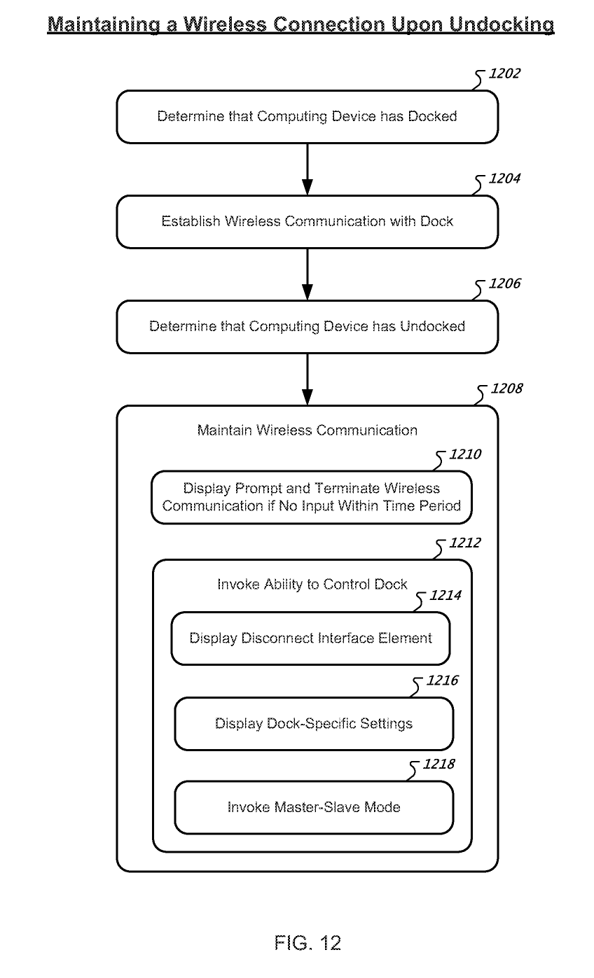

FIG. 12 shows a flowchart of an example process for maintaining a wireless connection upon unlocking. In box 1202, a mobile computing device determines that the device has docked. As an example, the mobile device may receive an electrical signal that was transmitted by the dock, and that indicates that the device has been docked.

In box 1204, the mobile device, upon determining that the device is docked, establishes wireless communication with the dock. For example, the mobile device may receive a BLUETOOTH address from the dock, and may establish a wireless connection with the dock using the BLUETOOTH address.

In box 1206, the mobile device may determine that the device has undocked. For example, the mobile device may determine that the electrical signal described above with reference to box 1202 terminates.

In 1208, the mobile computing device maintains the wireless communication with the dock even though the mobile device may no longer be docked. The communication may remain in effect for an extended period of time (e.g., one minute, five minutes, or sixty minutes), and may terminate, for example, upon (i) the mobile device turning off, or (ii) the user providing user input that causes the mobile device to terminate the wireless communication.

In box 1210, the mobile computing device displays a prompt upon unlocking. The prompt may state that the wireless communication may terminate if the user does not provide user input within a defined time period. For example, the prompt may include, for example: (i) text that states “Maintain Wireless Connection?”, (ii) a selectable interface element that states “Remain Connected” and (iii) a selectable interface element that states “Disconnect.” In some examples, the prompt includes a visual identification of a time that is remaining before the wireless communication terminates. For example, the prompt may include a numerical countdown in seconds, or may include horizontal bar that expands across the display. In various examples, the prompt is displayed within 0.5 seconds, 1 second, 3 seconds, or 5 seconds of the mobile device being undocked. The prompt may display without the user providing user input after the unlocking.

Such operation by a mobile telephone may involve “Opt-In” maintenance of the wireless communication. In another example, the user is provided a prompt to “Opt-Out” of the wireless communication. If the user does not provide input during the defined time period of display for the prompt, then the prompt may disappear and the wireless communication may remain connected. For example, the prompt may state “Disconnect Wireless Connection?”

In box 1212, the user of the mobile device is provided an ability to control the docking station's operation via the wireless communication. For example, upon undocking, the mobile computing device may display the docking station control interface.

In some examples the dock control interface may include dock-specific settings (box 1216). For example, the mobile computing device may be able to connect with two different types of docking stations, but only one of the types of docking stations may include speakers and an amplifier. Thus, docking station volume buttons may only display upon docking/undocking to the docking station with the speakers. The dock volume buttons may not be displayed upon docking/undocking to a docking station that does not include the speakers.

In some examples, the docking-station-specific settings are selectable user interface elements that are displayed when the mobile device has been docked/undocked, but not when the mobile device is presently docked. The dock-specific settings may be displayed for multiple types of docking stations.

In box 1218, the mobile computing device invokes a master-slave mode. As an example, upon undocking, the user may launch an environment control application program. Data for displaying a temperature control interface, ambient music or background sound interface, lighting interface, or the like may be received at the mobile computing device over a network, and the mobile computing device may transmit the data to the docking station. The docking station may forward the data over an auxiliary output line to the thermostat, the entertainment system, or the lighting elements or a controller. The mobile device may operate as a master device that presents options to the user for modifying environmental control aspects.

In various examples, a device when docked may make only an electrical charging connection through the physical docking interface, and may separately and automatically make a wireless connection to the docking station or to a device that is associated with the docking station. For example, when a device is docked in a station associated with an entertainment system, the device may begin charging and may also establish a BLUETOOTH or similar connection to the entertainment system for playing music stored (e.g., in MP3 format) on the device over the entertainment system. In this manner, when the device has charged, the user can take it out of the docking station while the music continues playing, and the user could, for example, walk around and use the device, in effect, as a remote control for the entertainment system (within the range of the wireless interface).

A wireless data connection of a may be created whenever the docking station and mobile computing device are connected. For example, a wireless handshaking function may occur between the two devices, and the devices may then exchange information that identifies the type of docking station, and thus the context in which the device communication has occurred.

In various examples, separate wired and wireless connections may be made between a mobile computing device and a docking station, or a device associated with a docking station, when the mobile computing device is physically docked. The wired connection may be a power connection in a familiar manner, and may be used to recharge the mobile device while it is docked. A wired data connection could also be provided, but that data connection may be broken if and when the mobile computing device is removed from the docking station. Thus, as an alternative to, or in addition to, the wired data connection, a wireless data connection may be formed automatically when the docking occurs. Such a connection may be used to transfer files or other information between the mobile computing device and the docking station or a device associated with the docking station, even after the device has been undocked.

Thus, for example, a user may dock their portable computing device to a music or video system, and a wireless handshaking negotiation may occur to establish a data link between the wireless computing device and the dock. The user may then choose to begin playing a media file, and the media file may play through the docking station such as when the dock is a speaker system, or through a device associated with the docking station, such as a video monitor connected to the docking station, where the docking station provides for television playing, recording, and similar functions, such as personal video recorder functions. After a time period, the user may want to take the mobile computing device with them but continue playing the media file or files that are stored on the mobile computing device. The user may thus undock the device, and the data transmission may continue over the wireless interface between the mobile computing device and the docking station. With the device undocked, the user may employ the device like a remote control, such as by moving throughout the user's home and changing media files, adjusting volume levels, changing rooms in which the media will be played, or other similar actions.

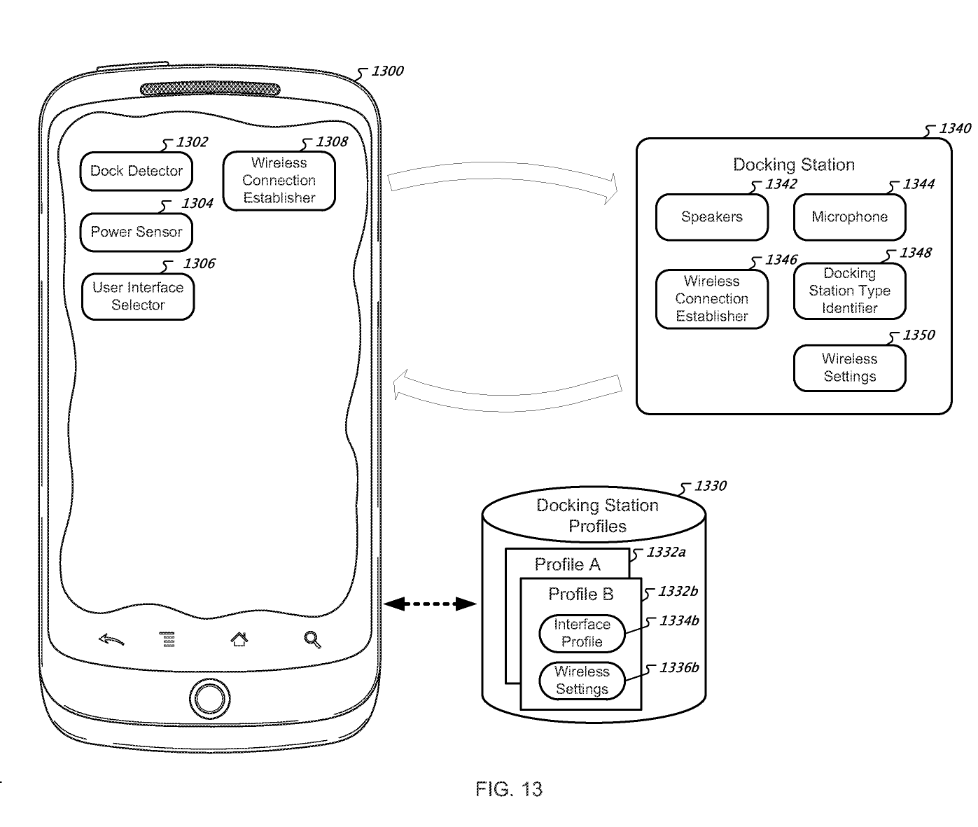

FIG. 13 shows an example system that includes a mobile computing device and a docking station. The mobile computing device 1300 and docking station 1340 are examples of the mobile devices and docking stations that are referenced throughout this document. The mobile computing device 1300 may operate in cooperation with a server system.

The dock detector 1302 determines that a mobile computing device has physically paired with a docking station. For example, the dock detector may determine that the mobile computing device has electrically coupled with a docking system that is adapted to supply electrical power for charging the mobile computing device. The dock detector may determine that the docking system is a first type of docking system from a plurality of types of docking system, for example, by performing at least some of the operations of the mobile computing device in FIG. 9 (e.g., boxes 652 to 664), and by communicating with the dock via conductive pad 606.

The power sensor 1304 may be arranged to detect when the computing device is attached to a power source that is for charging the mobile computing device. In various examples, the dock detector 1302 communicates with the power sensor 1304. In various examples, the power sensor 1304 is unable to distinguish between power that is being supplied through conductive pad 602 and power that is being supplied through the data terminal 610.

The wireless connection establisher 1308 establishes a wireless communication session between the mobile computing device and the docking system in response to the dock detector 1302 determining that the mobile computing device has physically paired with the docking system. Thus, the wireless connection establisher 1308 may perform at least some of the operations of the mobile computing device in FIG. 10 (e.g., boxes 716 to 732). The wireless connection establisher 1308 may use the docking station type (as determined by the dock detector 1302) to identify a corresponding profile 1332b, and access the wireless settings 1336b in the corresponding profile. The wireless settings 1336b may specify a previously saved wireless network identifier and authentication code for establishing the wireless connection with the docking station. The wireless settings 1336b may also specify types of wireless communication to activate between the mobile computing device and docking station, for example, whether the docking station should act as a speakerphone, and whether the device should audibly output audio that is generated by the mobile device.

The user interface selector 1306 may select a user interface profile for use by the mobile computing device 1300 in response to the dock type detector 1302 determining that the mobile computing device has electrically coupled with the docking system and determining the type of docking system. For example, the user interface selector 1306 may receive from the dock detector 1302 a type of docking station. The user interface selector 1306 may then use the type of docking station to access a corresponding profile from the repository of docking station profiles 1330. The corresponding profile may include settings for generating a unique graphical scheme for the user for example.

The docking station 1340, in some implementations, may include speakers 1342 and a microphone 1344, as described throughout this document. The docking station 1340 may also include a wireless connection establisher 1346 to establish a wireless connection with a mobile computing device which has docked in the docking station, for example, by performing the operations of boxes 710 through 730 in FIG. 10. The wireless connection establisher 1346 may send the docking station type identifier 1348 to the mobile device 1300, to enable the dock detector 1302 to determine the type of docking station that the mobile device has mated with. The docking station 1340 may also store wireless settings 1350 that are particular to the mobile device 1300. The wireless settings 1350 may include a wireless network identifier and authentication code that enables the docking station 1340 to establish a wireless connection with the mobile device 1300 (after an initial pairing) without exchanging an address and pin code.

In some implementations, the mobile computing device may be a handheld mobile telephone (e.g., a smartphone, or application telephone) that includes a touchscreen display device for presenting content to a user of the mobile computing device and receiving touch-based user inputs. In other examples, the mobile computing device may be a control device that lacks telephone capability.

Visual, auditory, and tactile output components may also be provided (e.g., LED lights, a speaker for providing tonal, voice-generated, or recorded output, or vibrating mechanisms for tactile output) by the mobile computing device, as may various different input components (e.g., keyboard, physical buttons, trackballs, and the like).

Example visual output mechanisms may display video, graphics, images, and text, and may coordinate user touch inputs locationally with the displayed information so that user contact above a displayed item may be associated with the item by the device. The mobile computing device may be able to determine a position of physical contact with the touchscreen display device (e.g., a position of contact by a finger or a stylus). Using the touchscreen, various “virtual” input mechanisms may be produced, where a user interacts with a graphical user interface element depicted on the touchscreen by contacting the graphical user interface element. An example of a “virtual” input mechanism is a “software keyboard,” where a keyboard is displayed on the touchscreen and a user selects keys by pressing a region of the touchscreen that corresponds to each key.

The mobile computing device may include mechanical or touch sensitive buttons. The device may include microphone that allows the mobile computing device to convert audible sounds into an electrical signal that may be digitally encoded and stored in computer-readable memory, or transmitted to another computing device. The mobile computing device may also include a digital compass, an accelerometer, proximity sensors, and ambient light sensors.

An operating system may provide an interface between the mobile computing device's hardware (e.g., the input/output mechanisms and a processor executing instructions retrieved from computer-readable medium) and software. Example operating systems include the ANDROID mobile device platform; APPLE IPHONE/MAC OS X operating systems; MICROSOFT WINDOWS 7/WINDOWS MOBILE operating systems; SYMBIAN operating system; RIM BLACKBERRY operating system; PALM WEB operating system; a variety of UNIX-flavored operating systems; or a proprietary operating system for computerized devices. In some examples, the operating system may be much simpler than the aforementioned examples. The operating system may provide a platform for the execution of application programs that facilitate interaction between the computing device and a user.

The mobile computing device may present a graphical user interface with the touchscreen. A graphical user interface is a collection of one or more graphical interface elements and may be static (e.g., the display appears to remain the same over a period of time), or may be dynamic (e.g., the graphical user interface includes graphical interface elements that animate without user input).

A graphical interface element may be text, lines, shapes, images, or combinations thereof. For example, a graphical interface element may be an icon that is displayed on the desktop and the icon's associated text. In some examples, a graphical interface element is selectable with user-input. For example, a user may select a graphical interface element by pressing a region of the touchscreen that corresponds to a display of the graphical interface element. In some examples, the user may manipulate a trackball to highlight a single graphical interface element as having focus. User-selection of a graphical interlace element may invoke a pre-defined action by the mobile computing device. In some examples, selectable graphical interlace elements further or alternatively correspond to a button on the keyboard. User-selection of the button may invoke the pre-defined action.

User-input may manipulate a sequence of mobile computing device operations. For example, a single-action user input (e.g., a single tap of the touchscreen, swipe across the touchscreen, contact with a button, or combination of these at a same time) may invoke an operation that changes a display of the user interface. Without the user-input, the user interface may not have changed at a particular time.

The mobile computing device may include other application modules and hardware. A call handling unit may receive an indication of an incoming telephone call and provide to a user capabilities to answer the incoming telephone call. A media player may allow a user to listen to music or play movies that are stored in local memory of the mobile computing device. The mobile telephone may include a digital camera sensor, and corresponding image and video capture and editing software. An internet browser may enable the user to view content from a web page by typing in an addresses corresponding to the web page or selecting a link to the web page.

The mobile computing device may include an antenna to wirelessly communicate information other devices. The computing device may alternatively or additionally communicate over a wired connection.

In some examples, the mobile computing device may communicate with a personal computer, such as the home computer for a user of the mobile computing device.

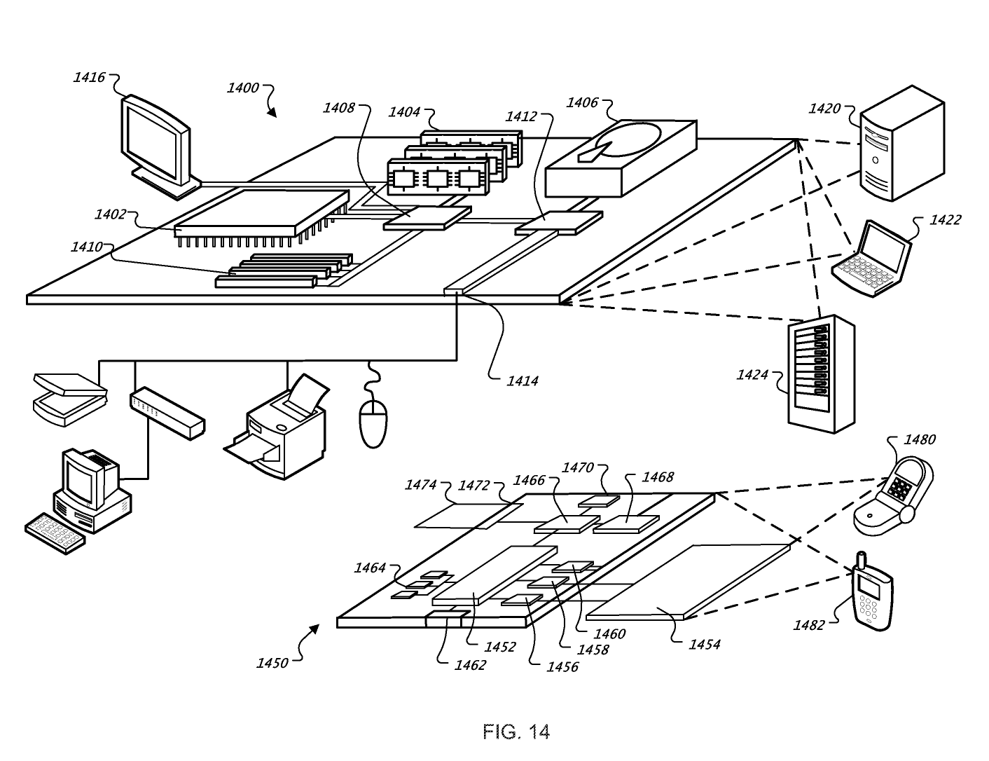

FIG. 14 is a block diagram of computing devices 1400, 1450 that may be used to implement the systems and methods described in this document, as either a client or as a server or plurality of servers. Computing device 1400 is intended to represent various forms of digital computers, such as laptops, desktops, workstations, personal digital assistants, servers, blade servers, mainframes, and other appropriate computers. Computing device 1450 is intended to represent various forms of mobile devices, such as personal digital assistants, cellular telephones, smartphones, and other similar computing devices. Additionally computing device 1400 or 1450 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be examples only, and are not meant to limit implementations described and/or claimed in this document.

Computing device 1400 includes a processor 1402, memory 1404, a storage device 1406, a high-speed interface 1408 connecting to memory 1404 and high-speed expansion ports 1410, and a low speed interface 1412 connecting to low speed bus 1414 and storage device 1406. Each of the components 1402, 1404, 1406, 1408, 1410, and 1412, are interconnected using various busses, and may be mounted on a common motherboard or in other manners as appropriate. The processor 1402 can process instructions for execution within the computing device 1400, including instructions stored in the memory 1404 or on the storage device 1406 to display graphical information for a GUI on an external input/output device, such as display 1416 coupled to high speed interface 1408. In other implementations, multiple processors and/or multiple buses may be used, as appropriate, along with multiple memories and types of memory. Also, multiple computing devices 1400 may be connected, with each device providing portions of the necessary operations (e.g., as a server bank, a group of blade servers, or a multi-processor system).

The memory 1404 stores information within the computing device 1400. In one implementation, the memory 1404 is a volatile memory unit or units. In another implementation, the memory 1404 is a non-volatile memory unit or units. The memory 1404 may also be another form of computer-readable medium, such as a magnetic or optical disk.

The storage device 1406 is capable of providing mass storage for the computing device 1400. In one implementation, the storage device 1406 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1404, the storage device 1406, or memory on processor 1402.

The high speed controller 1408 manages bandwidth-intensive operations for the computing device 1400, while the low speed controller 1412 manages lower bandwidth-intensive operations. Such allocation of functions is an example only. In one implementation, the high-speed controller 1408 is coupled to memory 1404, display 1416 (e.g., through a graphics processor or accelerator), and to high-speed expansion ports 1410, which may accept various expansion cards (not shown). In the implementation, low-speed controller 1412 is coupled to storage device 1406 and low-speed expansion port 1414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through network adapter.

The computing device 1400 may be implemented in a number of different forms, as shown in the figure. For example, it may be implemented as a standard server 1420, or multiple times in a group of such servers. It may also be implemented as part of a rack server system 1424. In addition, it may be implemented in a personal computer such as a laptop computer 1422. Alternatively, components from computing device 1400 may be combined with other components in a mobile device (not shown), such as device 1450. Each of such devices may contain one or more of computing device 1400, 1450, and an entire system may be made up of multiple computing devices 1400, 1450 communicating with each other.

Computing device 1450 includes a processor 1452, memory 1464, an input/output device such as a display 1454, a communication interface 1466, and a transceiver 1468, among other components. The device 1450 may also be provided with a storage device, such as a microdrive or other device, to provide additional storage. Each of the components 1450, 1452, 1464, 1454, 1466, and 1468, are interconnected using various buses and several of the components may be mounted on a common motherboard or in other manners as appropriate.

The processor 1452 can execute instructions within the computing device 1450, including instructions stored in the memory 1464. The processor may be implemented as a chipset of chips that include separate and multiple analog and digital processors. Additionally, the processor may be implemented using any of a number of architectures. For example, the processor 410 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 1450, such as control of user interfaces, applications run by device 1450, and wireless communication by device 1450.

Processor 1452 may communicate with a user through control interface 1458 and display interface 1456 coupled to a display 1454. The display 1454 may be, for example, a TFT (Thin-Film-Transistor Liquid Crystal Display) display or an OLED (Organic Light Emitting Diode) display, or other appropriate display technology. The display interface 1456 may comprise appropriate circuitry for driving the display 1454 to present graphical and other information to a user. The control interface 1458 may receive commands from a user and convert them for submission to the processor 1452. In addition, an external interface 1462 may be provide in communication with processor 1452, so as to enable near area communication of device 1450 with other devices. External interface 1462 may provide, for example, for wired communication in some implementations, or for wireless communication in other implementations, and multiple interfaces may also be used.

The memory 1464 stores information within the computing device 1450. The memory 1464 can be implemented as one or more of a computer-readable medium or media, a volatile memory unit or units, or a non-volatile memory unit or units. Expansion memory 1474 may also be provided and connected to device 1450 through expansion interface 1472, which may include, for example, a SIMM (Single In Line Memory Module) card interface. Such expansion memory 1474 may provide extra storage space for device 1450, or may also store applications or other information for device 1450. Specifically, expansion memory 1474 may include instructions to carry out or supplement the processes described above, and may include secure information also. Thus, for example, expansion memory 1474 may be provide as a security module for device 1450, and may be programmed with instructions that permit secure use of device 1450. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1464, expansion memory 1474, or memory on processor 1452 that may be received, for example, over transceiver 1468 or external interface 1462.

Device 1450 may communicate wirelessly through communication interface 1466, which may include digital signal processing circuitry where necessary. Communication interface 1466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1468. In addition, short-range communication may occur, such as using a Bluetooth, WiFi, or other such transceiver (not shown). In addition, GPS (Global Positioning System) receiver module 1470 may provide additional navigation- and location-related wireless data to device 1450, which may be used as appropriate by applications running on device 1450.

Device 1450 may also communicate audibly using audio codec 1460, which may receive spoken information from a user and convert it to usable digital information. Audio codec 1460 may likewise generate audible sound for a user, such as through a speaker, e.g., in a handset of device 1450. Such sound may include sound from voice telephone calls, may include recorded sound (e.g., voice messages, music files, etc.) and may also include sound generated by applications operating on device 1450.

The computing device 1450 may be implemented in a number of different forms, as shown in the figure. For example, it may be implemented as a cellular telephone 1480. It may also be implemented as part of a smartphone 1482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as program software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. Moreover, other mechanisms for performing the systems and methods described in this document may be used. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A computer-implemented system comprising:
a dock detector on a mobile computing device arranged to identify a type of docking station to which the mobile computing device has been physically coupled, the identified type of docking station selected from a plurality of different possible docking station types, including a docking station type that is associated with a light switch;
a repository of electronically stored user interface profiles that specify different schemes for presentations of information with the mobile computing device, each user interface profile corresponding to a type of docking station from the plurality of types of docking stations; and
a user interface selector that is programmed to select, in response to the dock detector determining that the mobile computing device has been mounted to a docking station of a type that is associated with a light switch, a first user interface profile from the repository that causes the mobile computing device to be responsive to input to alter an illumination state of a lighting element associated with the light switch.

2. The system of claim 1, further comprising a wall-mountable docking station adapted to be mounted in proximity to the light switch and to supply electrical power to the mobile computing device.

3. The system of claim 2, wherein the wall-mountable docking station includes a housing that is adapted to at least partially surround the light switch.

4. The system of claim 3, wherein the light switch is accessible for actuation when the mobile computing device is not docked in the wall-mountable docking system, and wherein an actuation of the light switch results in an alteration of an illumination state of the lighting element.

5. The system of claim 3, wherein the light switch is inaccessible for actuation when the mobile computing device is docked in the wall-mountable docking system.

6. The system of claim 5, wherein an actuation of the light switch does not result in an alteration of an illumination state of the lighting element.

7. The system of claim 2, wherein the wall-mountable docking station includes a housing that is adapted to be mounted adjacent the light switch.

8. The system of claim 7, wherein the light switch is accessible for actuation when the mobile computing device is not docked in the wall-mountable docking system, and wherein an actuation of the light switch results in an alteration of an illumination state of the lighting element.

9. The system of claim 7, wherein an actuation of the light switch when the mobile computing device is docked in the wall-mountable docking system does not result in an alteration of an illumination state of the lighting element.

10. The system of claim 2, further comprising a second docking station adapted to supply electrical power to the mobile computing device;
wherein the dock detector is further programmed to determine that the mobile computing device has electrically coupled with the second docking station and determine that the second docking station is a second type of docking station from the plurality of types of docking stations, and
wherein user interface selector is further programmed to select a second user interface profile from the repository of user interface profiles based on the selected second user interface profile corresponding to the second type of docking station.

11. A computer-implemented method comprising:
determining that a mobile computing device has electrically coupled by physical contact with a wall-mounted docking station mounted in proximity to a light switch, the wall-mounted docking station being adapted to supply electrical power for charging the mobile computing device;
determining that the wall-mounted docking station is a first type of docking station from a plurality of types of docking stations;
selecting a first user interface profile that corresponds to the first type of docking station from among a plurality of user interface profiles, each of the plurality of user interface profiles corresponding to a respective type of docking station from the plurality of types of docking stations; and
presenting, by the mobile computing device for display, the first user interface profile in response to selecting the first user interface profile, the first user interface profile being responsive to an input at the mobile computing device to alter an illumination state of a lighting element associated with the light switch.

12. The method of claim 11, wherein determining that the docking station is the first type of docking station includes receiving an electrical signal from the docking station that identifies the docking station as the first type of docking station in distinction to other of the plurality of types of docking stations.

13. The method of claim 12, wherein each of the plurality of types of docking stations receives the electrical signal over a same electrical interface configuration.

14. The method of claim 11, further comprising:
determining that the mobile computing device has not electrically coupled with the docking station before; and in response,
presenting, by the mobile computing device for display, a first configuration user interface as part of the first user interface profile.

15. A computer-readable storage device storing instructions that, when executed by one or more processing devices, perform operations comprising:
determining that a mobile computing device has electrically coupled by physical contact with a wall-mounted docking station mounted in proximity to a light switch, the wall-mounted docking station being adapted to supply electrical power for charging the mobile computing device;
determining that the wall-mounted docking station is a first type of docking station from a plurality of types of docking stations;
selecting a first user interface profile that corresponds to the first type of docking station from among a plurality of user interface profiles, each of the plurality of user interface profiles corresponding to a respective type of docking station from the plurality of types of docking stations; and
presenting, by the mobile computing device for display, the first user interface profile in response to selecting the first user interface profile, the first user interface profile being responsive to an input at the mobile computing device to alter an illumination state of a lighting element associated with the light switch.

16. A computer-implemented system comprising:
a dock detector that is programmed to (i) determine that a mobile computing device has coupled for charging with a wall-mounted docking station that is mounted in proximity to a wall-mounted light switch, and (ii) determine that the wall-mounted docking station is a first type of docking station from a plurality of types of docking stations;
a repository of electronically stored user interface profiles that specify different schemes for presentations of information with the mobile computing device, each user interlace profile corresponding to a type of docking station from the plurality of types of docking stations; and
a user interface selector that is programmed to select a first user interface profile from the repository of user interface profiles based on the selected user interface profile corresponding to the first type of docking station, the first user interface profile being selected for use by the mobile computing device in response to the dock detector determining that the mobile computing device has coupled with the wall-mounted docking station and that the wall-mounted docking station is a first type of docking station, wherein the first user interface profile is responsive to an input at the mobile computing device to alter an illumination state of a lighting element associated with the wall-mounted light switch.

17. The system of claim 16, further comprising a wall-mountable docking station adapted to be mounted in proximity to the wall-mounted light switch and to supply electrical power to the mobile computing device.

18. The system of claim 16, wherein the dock detector is programmed to determine that the mobile computing device has electrically coupled for charging with the wall-mounted docking station.

19. The system of claim 16, wherein the dock detector is programmed to determine that the mobile computing device has inductively coupled for charging with the wall-mounted docking station.

20. The system of claim 16, wherein the dock detector is programmed to determine that the mobile computing device is not docked in the wall-mounted docking station but is within a proximity of the wall-mounted docking station, and, in response, wherein a user interface of the mobile computing device is updated to provide a control that can be used to alter an illumination state of the lighting element associated with the wall-mounted light switch.
